(19) United States
(12) Patent Application Publication
(10) Pub. No.: US 2024/0205140 A1
(43) Pub. Date: Jun. 20, 2024

(54) LOW LATENCY PATH FAILOVER TO AVOID NETWORK BLACKHOLES AND SCHEDULER FOR CENTRAL PROCESSING UNIT ENGINES FOR HARDWARE OFFLOADED ARTIFICIAL INTELLIGENCE/MACHINE LEARNING WORKLOADS AND LOW POWER SYSTEM FOR ACOUSTIC EVENT DETECTION

(71) Applicant: Meta Platforms, Inc., Menlo Park, CA (US)

(72) Inventors: Zeeshan Altaf Lokhandwala, Redwood City, CA (US); Arvind Srinivasan, San Jose, CA (US)

(21) Appl. No.: 18/459,356

(22) Filed: Aug. 31, 2023

Related U.S. Application Data
(60) Provisional application No. 63/487,231, filed on Feb. 27, 2023.

(51) Int. Cl. H04L 45/28; H04L 45/00; H04L 45/02

(52) U.S. Cl. CPC H04L 45/28; H04L 45/02; H04L 45/22

(57) ABSTRACT

A system for adapting to a partially unhealthy network and bypassing failures associated with the network is provided. The system may enable determining a designated network path configured to transfer traffic data from a first communication device, via one or more network switches, to a second communication device. The system may enable determining at least one network failure, associated with the network path, causing at least a subset of the traffic data to be blocked along the network path. The system may enable determining one or more tracker windows associated with one or more other network paths that are available to transfer traffic content. The system may enable selecting at least one network path of the one or more other network paths to transfer the at least the subset of the traffic data to the second communication device.

### CROSS-REFERENCE TO RELATED APPLICATIONS

This application is a non-provisional of U.S. Provisional Application No. 63/487,231 filed Feb. 27, 2023 entitled “Low latency path failover to avoid network blackholes for high performance artificial intelligence/machine learning,” the entire contents of which are incorporated in its entirety herein by reference.

### TECHNOLOGICAL FIELD

The examples of the present disclosure may relate generally to methods, apparatuses and computer program products for mitigating network failures associated with Remote Direct Memory Access (RDMA) transport communication devices in high-performance artificial intelligence (AI) and machine learning (ML) networks.

### BACKGROUND

Remote Direct Memory Access may allow for direct access of memory from memory of one device to the memory of another device. RDMA may help increase the efficiency of data centers by providing low latency and high throughput data transfers. High-performance artificial intelligence and machine learning applications may utilize high bandwidth network communication and predictable tail latency. Congestion on a network may directly affect the tail latencies and may thereby affect the performance of end applications associated with the network. Additionally, device failures across the network may cause loss of data traffic or may increase network jitter associated with inefficient reattempts to transfer data traffic across the network.

Therefore, there may be a need to manage congestion and mitigate network failures associated with high-performance AI/ML applications.

### BRIEF SUMMARY

Some examples of the present disclosure may relate to mechanisms to mitigate network blackholes as part of network aware per packet load balancing techniques which may be utilized in RDMA transport (e.g., RDMA over converged ethernet (RoCE)) communication devices (e.g., endpoints). In this regard, some examples of the present disclosure may reduce jitter in the presence of a network failure by facilitating a low latency detection and automatic failover detection. Network blackholes may occur due to a variety of reasons such as, for example, network link failures, network switch failures and/or network switch misconfigurations. The network blackholes may cause jitter (i.e., undesirable latency (e.g., time delay) associated with transfer of data traffic across the network to a receiver entity.

Some examples of the present disclosure may facilitate high performance transport to detect failures in, or associated with, the network dynamically and may facilitate redistribution of network traffic to available network paths to be load balanced and may minimize or reduce jitter associated with network blackholes.

In one example of the present disclosure, a method for adapting to a partially unhealthy network and bypassing failures associated with the network is provided. The method may include determining a designated network path configured to transfer traffic data from a first communication device, via one or more network switches, to a second communication device. The method may further include determining at least one network failure, associated with the network path, causing at least a subset of the traffic data to be blocked along the network path. The method may further include determining one or more tracker windows associated with one or more other network paths that are available to transfer traffic content. The method may further include selecting at least one network path of the one or more other network paths to transfer the at least the subset of the traffic data to the second communication device.

In another example of the present disclosure, an apparatus for adapting to a partially unhealthy network and bypassing failures associated with the network is provided. The apparatus may include one or more processors and a memory including computer program code instructions. The memory and computer program code instructions are configured to, with at least one of the processors, cause the apparatus to at least perform operations including determining a designated network path configured to transfer traffic data from a first communication device, via one or more network switches, to a second communication device. The memory and computer program code are also configured to, with the processor, cause the apparatus to determine at least one network failure, associated with the network path, causing at least a subset of the traffic data to be blocked along the network path. The memory and computer program code are also configured to, with the processor, cause the apparatus to determine one or more tracker windows associated with one or more other network paths that are available to transfer traffic content. The memory and computer program code are also configured to, with the processor, cause the apparatus to select at least one network path of the one or more other network paths to transfer the at least the subset of the traffic data to the second communication device.

In yet another example of the present disclosure, a computer program product for adapting to a partially unhealthy network and bypassing failures associated with the network is provided. The computer program product includes at least one computer-readable storage medium having computer-executable program code instructions stored therein. The computer-executable program code instructions may include program code instructions configured to determine a designated network path configured to transfer traffic data from a first communication device, via one or more network switches, to a second communication device. The computer program product may further include program code instructions configured to determine at least one network failure, associated with the network path, causing at least a subset of the traffic data to be blocked along the network path. The computer program product may further include program code instructions configured to determine one or more tracker windows associated with one or more other network paths that are available to transfer traffic content. The computer program product may further include program code instructions configured to select at least one network path of the one or more other network paths to transfer the at least the subset of the traffic data to the second communication device.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an example of the present disclosure.

FIG. 2 is a diagram of an exemplary computing device in accordance with an example of the present disclosure.

FIG. 3 is a diagram of an exemplary communication device in accordance with an example of the present disclosure.

FIG. 4 is a diagram of an exemplary computing system in accordance with an example of the present disclosure.

FIG. 5 is a diagram of an exemplary network topology in accordance with an example of the present disclosure.

FIG. 6 is a diagram of a process for operations to adapt to a partially unhealthy network and bypassing failures associated with the network in accordance with an example of the present disclosure.

FIG. 7 is a diagram of an exemplary network environment in accordance with an example of the present disclosure.

FIG. 8 is a diagram of an exemplary computing device in accordance with an example of the present disclosure.

FIG. 9 is a diagram illustrating an exemplary system and exemplary process for scheduling one or more central processing units to facilitate requests from one or more applications and/or one or more entities in accordance with an example of the present disclosure.

FIG. 10 is a diagram of an exemplary process for operations to schedule one or more central processing units to facilitate requests for processing in accordance with an example of the present disclosure.

FIG. 11 illustrates an example system including a head-mounted device that may include, or be associated with other devices, in accordance with one or more examples of the present disclosure.

FIG. 12A illustrates an example electronic device configured to implement the subject technology in accordance with one or more examples of the present disclosure.

FIG. 12B illustrates an example artificial reality system including a head-mounted device in accordance with examples of the present disclosure.

FIG. 13 illustrates a flow diagram of an exemplary process for training a machine learning model, in accordance with one or more examples of the present disclosure.

FIG. 14 illustrates an example training process for a teacher model, in accordance with one or more examples of the present disclosure.

FIG. 15 illustrates an example training process for a student model, in accordance with one or more examples of the present disclosure.

FIG. 16 illustrates an example flowchart illustrating operations for detecting acoustic events for electronic devices according to some examples of the present disclosure.

FIG. 17 illustrates an example machine learning framework including machine learning model and training database, in accordance with one or more examples of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a switch fabric, switched fabric or switching fabric may refer to a network topology in which one or more nodes (e.g., network nodes) may be connected by one or more switches (e.g., network switches) The switch fabric, switched fabric or switching fabric may spread network data traffic across multiple network paths and/or multiple links.

As referred to herein, incasts may, for example, be transmitter endpoints transmitting data, traffic, content, and/or the like, to associated receiver endpoints.

It is to be understood that the methods and systems described herein are not limited to specific methods, specific components, or to particular implementations. It is also to be understood that the terminology used herein is for the purpose of describing particular embodiments only and is not intended to be limiting.

### A. Low Latency Path Failover to Avoid Network Blackholes for High Performance Artificial Intelligence Machine Learning

### Exemplary System Architecture

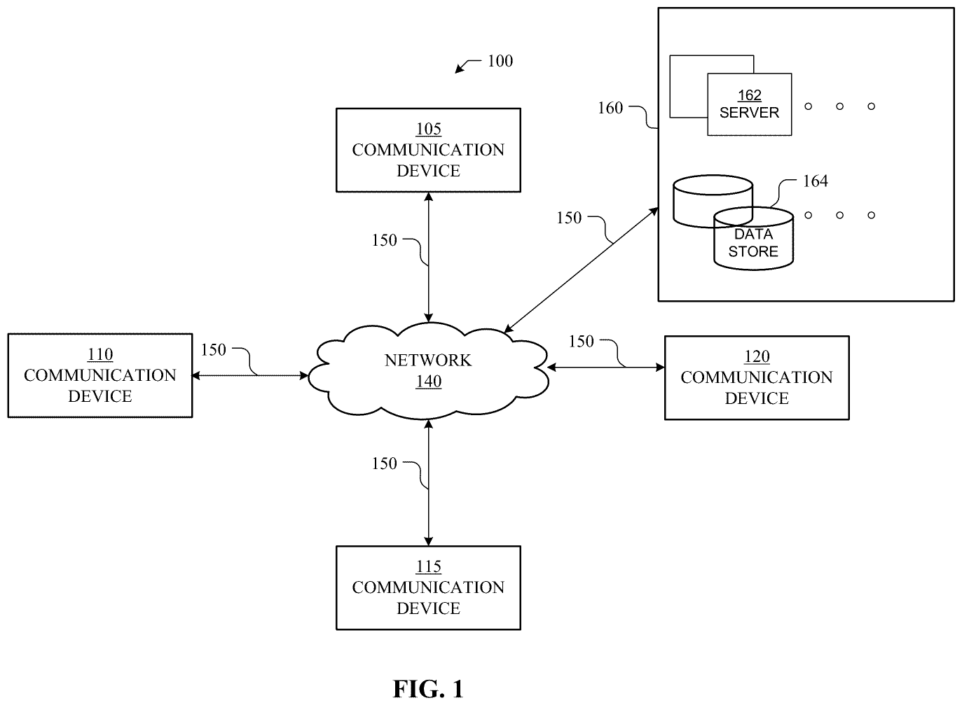

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

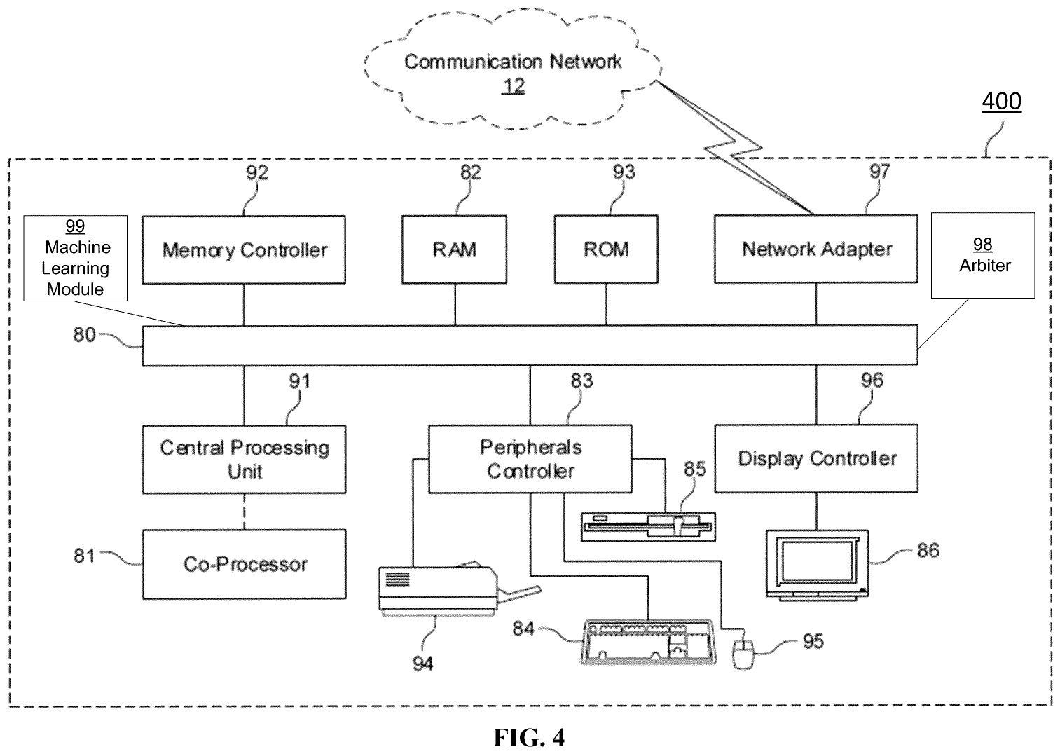

In some examples of the present disclosure, communication devices 105, 110, 115, 120 may be electronic devices including hardware, software, or embedded logic components or a combination of two or more such components and capable of carrying out the appropriate functionalities implemented or supported by the communication devices 105, 110, 115, 120. The communication devices 105, 110, 115, 120 may be any kind/type of AI/ML accelerator, such as for example graphics processing units (GPUs). The communication devices 105, 110, 115, 120 may include or be associated with a network interface card (NIC) configured to implement an RDMA engine for performing RDMA communications. The RDMA engine may be based on a networking protocol that allows RDMA over an Ethernet network (referred to as RDMA over Converged Ethernet or RoCE), which may be on the Ethernet level or the Internet level. In some examples, the communication devices 105, 110, 115, 120 may be network switches (e.g., network switch devices). For instance, in some examples the communication devices 105, 110, 115, 120 may be one or more switches capable of transmitting and/or receiving data between each other and other switches and/or other devices (e.g., nodes (e.g., computing system 400 of FIG. 4)) across a network (e.g., network 140). In some examples, the communication devices 105, 110, 115, 120 may be cluster training switches (CTSWs) and/or rack training switches (RTSWs). The CTSWs may also be referred to herein as spine switches and the RTSWs may also be referred to herein as leaf switches. The communication devices 105, 110, 115, 120 may also be any other suitable types of network switches.

In other examples of the present disclosure, as an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

In some examples, the network device 160 may be one or more transmitter entities, receiver entities, nodes, network switches, servers (e.g., network servers) and/or the like. For instance, the network device 160 may be one or more transmitter entities, receiver entities, nodes, switches, servers and/or the like that establish a connection (e.g., via wide area network (WAN), local area network (LAN), etc.) between one or more communication devices 105, 110, 115, 120. For example, the network device 160 may be a node that connects the communication devices 105, 110, 115, 120 so that they may communicate with each other and any other communication devices (e.g., other nodes) that are connected to, or associated with the same network device 160 (e.g., directly or indirectly). In some examples, the network device 160 may be CTSWs and/or RTSWs. The network device 160 may also be any other suitable type(s) of network switch(es).

In some other examples of the present disclosure, the network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120 any suitable number of network devices 160 and communication devices 105, 110, 115 and 120 may be part of the system of FIG. 1 without departing from the spirit and scope of the present disclosure.

### Exemplary Computing Device

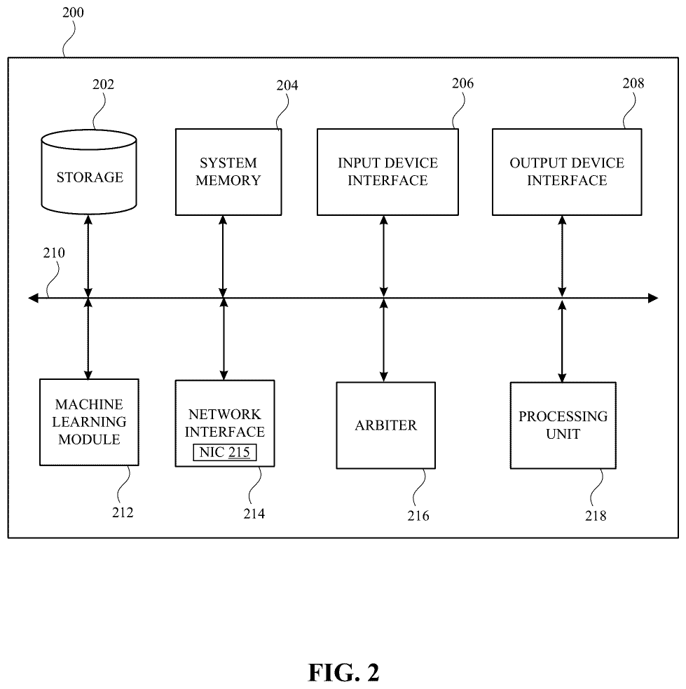

FIG. 2 illustrates an example computing device 200, in accordance with one or more examples of the present disclosure. The computing device 200 may be, and/or may be a part of, an accelerator for AI/ML applications (e.g., GPUs, field-programmable gate arrays (FPGAs), application-specific integrated circuits (ASICs)). The computing device 200 may include various types of computer-readable media and interfaces for various other types of computer-readable media. The computing device 200 includes a bus 210, a system memory 204, a storage device 202, an input device interface 206, an output device interface 208, a machine learning module 212, a network interface 214, an arbiter 216, and a processing unit 218, or subsets and variations thereof. Not all depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The bus 210 collectively represents all system, peripheral, and chipset buses that communicatively connect the numerous internal devices of the computing device 200. In one or more embodiments, the bus 210 communicatively connects the processing unit 218 with the other components of the computing device 200. From various memory units, the processing unit 218 retrieves instructions to execute and data to process in order to execute the operations of the subject disclosure. The processing unit 218 may be a controller and/or a single or multi-core processor or processors in various embodiments.

The storage device 202 may be a read-and-write memory device. The storage device 202 may be a non-volatile memory unit that stores instructions and data (e.g., static and dynamic instructions and data) even when the computing device 200 is off. In one or more embodiments, a mass-storage device (such as a magnetic or optical disk and its corresponding disk drive) may be used as the storage device 202. In one or more embodiments, a removable storage device (such as a floppy disk, flash drive, and its corresponding disk drive) may be used as the storage device 202.

Like the storage device 202, the system memory 204 may be a read-and-write memory device. However, unlike the storage device 202, the system memory 204 may be a volatile read-and-write memory, such as random-access memory. The system memory 204 may store any of the instructions and data that one or more processing unit 218 may need at runtime to perform operations. In one or more example embodiments, the processes of the subject disclosure may be stored in the system memory 204 and/or the storage device 202. From these various memory units, the one or more processing units 218 may retrieve instructions to execute and data to process in order to execute the processes of one or more embodiments, discussed below. The system memory 204 may include one or more buffers. Buffers for RDMA applications may include send queues, receive queues, completion queues, work queue elements (e.g., work-descriptor queue elements), completion queue elements, and/or the like.

Embodiments within the scope of the present disclosure may be partially or entirely realized using a tangible computer-readable storage medium (or multiple tangible computer-readable storage media of one or more types) encoding one or more instructions. The tangible computer-readable storage medium also may be non-transitory in nature.

The computer-readable storage medium may be any storage medium that may be read, written, or otherwise accessed by a general purpose or special purpose computing device, including any processing electronics and/or processing circuitry capable of executing instructions. For example, without limitation, the computer-readable medium may include any volatile semiconductor memory (e.g., the system memory 204), such as RAM, DRAM, SRAM, T-RAM, Z-RAM, and TTRAM. The computer-readable medium also may include any non-volatile semiconductor memory (e.g., the storage device 202), such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium may include any non-semiconductor memory, such as optical disk storage, magnetic disk storage, magnetic tape, other magnetic storage devices, or any other medium capable of storing one or more instructions. In one or more embodiments, the tangible computer-readable storage medium may be directly coupled to a computing device, while in other embodiments, the tangible computer-readable storage medium may be indirectly coupled to a computing device, e.g., via one or more wired connections, one or more wireless connections, or any combination thereof.

Instructions may be directly executable or may be used to develop executable instructions. For example, instructions may be realized as executable or non-executable machine code or as instructions in a high-level language that may be compiled to produce executable or non-executable machine code. Further, instructions also may be realized as or may include data. Computer-executable instructions also may be organized in any format, including routines, subroutines, programs, data structures, objects, modules, applications, applets, functions, etc. As recognized by those of skill in the art, details including, but not limited to, the number, structure, sequence, and organization of instructions may vary significantly without varying the underlying logic, function, processing, and output.

While the above discussion primarily refers to microprocessors or multi-core processors that execute software, one or more embodiments are performed by one or more integrated circuits, such as ASICs or FPGAs. In one or more embodiments, such integrated circuits execute instructions that are stored on the circuit itself.

The bus 210 also connects to the input device interface 206 and output device interface 208. The input device interface 206 enables the system to receive inputs. For example, the input device interface 206 allows a user to communicate information and select commands on the computing device 200. The input device interface 206 may be used with input devices such as keyboards, mice, dials, switches, sliders, and other interfaces (physical or virtual) for a user to supply information to the computing device 200. The output device interface 208 may be used with output devices such as displays, speakers, and other interfaces (physical or virtual) for the computing device 200 to provide information. One or more example embodiments may include devices that function as both input and output devices, such as a touchscreen.

The computing device 200 may also contain a machine learning module 212. The machine learning module 212 may be a hardware and/or software module that includes machine learning logic. Machine learning logic may be embodied in the form of computer-readable instructions and may include representation learning, feature learning, convolutional neural networks, artificial neural networks, graph neural networks, attention models, image recognition models, and the like. The machine learning module 212 may include one or more accelerators for AI/ML applications. The accelerators may be a GPU, FPGA, ASIC, and the like.

The bus 210 also couples the computing device 200 to one or more networks and/or to one or more network nodes through the network interface 214. The network interface 214 may include one or more interfaces that allow the computing device 200 to be a part of a network of computers (e.g., a local area network (LAN), a wide area network (WAN), or a network of networks (the Internet)). For example, the network interface 214 may include a network interface card (NIC) 215. In one or more implementations, the NIC 215 may be associated with one or more accelerators of the machine learning module 212.

The computing device 200 may also include an arbiter 216. The arbiter 216 may be a hardware and/or software module that may include machine learning logic. The arbiter 216 may determine a state for each of the available paths/flows associated with a network (e.g., network 140) and may maintain or save the states as a tracker as part of a transport reliability layer. In this regard, the arbiter 216 may keep track of all the outstanding packets on a particular flow(s)/path(s) (e.g., mapped to specific network paths) and may retransmit packets which may not be acknowledged (acked) by a receiver. The arbiter 216 facilitating tracking on a flow(s)/network path(s) may allow the examples of the present disclosure to make progress independently in a non-blocking manner. The arbiter 216 may also detect one or more instances in which a network path(s) may be blocked/congested (for example, based on many unacknowledged (un-acked) packets). In this regard, the arbiter 216 may avoid scheduling packets on the blocked/congested network path(s) and may prioritize a network path(s) with more space/bandwidth available. In one or more implementations, the arbiter 216 may be associated with one or more accelerators of the machine learning module 212 and/or the network interface 214.

### Exemplary Communication Device

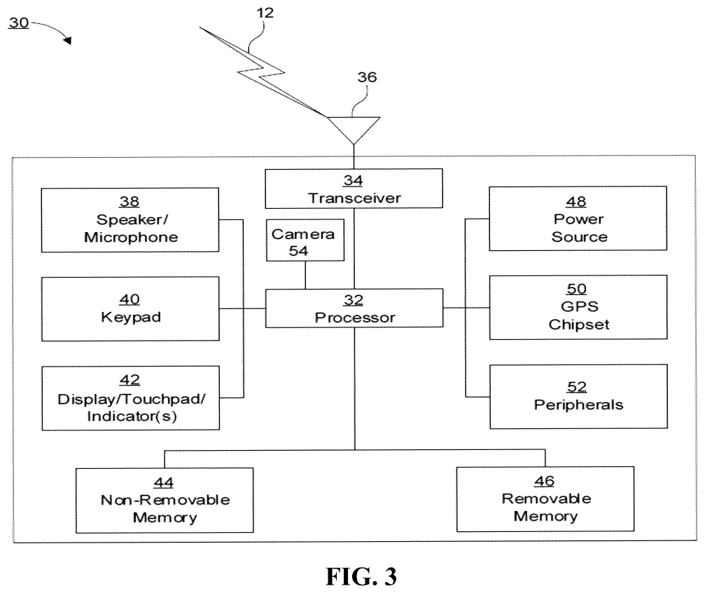

FIG. 3 illustrates a block diagram of an exemplary hardware/software architecture of a communication device such as, for example, user equipment (UE) 30. In some exemplary embodiments, the UE 30 may be any of communication devices 105, 110, 115, 120. In some exemplary embodiments, the UE 30 may be a network switch, a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 3, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

FIG. 4 is a block diagram of an exemplary computing system 400. In some examples of the present disclosure, the network device 160, and/or computing device 200 may be examples of the computing system 400. The computing system 400 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 400 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 400 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus. In some examples of the present disclosure, the computing system 400 may include a machine learning module 99. In some examples, the machine learning module 99 may be an example of the machine learning module 212 of FIG. 2. The machine learning module 99 may be a hardware and/or software module that includes machine learning logic. The machine learning logic may be embodied in the form of computer-readable instructions and may include representation learning, feature learning, convolutional neural networks, artificial neural networks, graph neural networks, attention models, image recognition models, and/or the like. The machine learning module 99 may include one or more accelerators for AI/ML applications. The accelerators may be a GPU, FPGA, ASIC, and/or the like.

In some examples of the present disclosure, the computing system 400 may include an arbiter 98. The arbiter 98 may an example of the arbiter 216 of FIG. 2 and may determine a state for each of the available paths/flows associated with a network (e.g., network 140) and may maintain or save the states as a tracker as part of a transport reliability layer. The arbiter 98 may also perform the similar functions described above with respect to arbiter 216 of FIG. 2.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 400 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 400. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, the computing system 400 may contain communication circuitry, such as for example a network adaptor 97, that may be used to connect computing system 400 to an external communications network, such as network 12 of FIG. 3, to enable the computing system 400 to communicate with other nodes (e.g., UE 30) of the network. In some examples, the network adapter 97 may be an example of network interface 214 of FIG. 2 and may perform similar functions of the network interface 214.

### Exemplary System Operation

High performance artificial intelligence applications may require very high bandwidth network communication along with predictable tail latency. Any congestion (e.g., blocked network traffic) on a network may directly affect the tail latencies and thereby may affect the performance of the end applications or endpoints (e.g., transmitter and/or receiver devices) associated with the network. Given a fully provisioned AI cluster(s) and/or ML cluster(s), the following features may allow a network to maximize performance and reduce the tail latencies.

Per packet load balancing to mitigate congestion hotspots on a switch fabric.

Efficient data loss recovery to recover any lost network packets in the event of a transient congestion occurrence.

Incast avoidance at a receiver to prevent buffer build up and data drops at the receiving network ports.

However, these above features may not remedy all instances of network congestion. Additionally, the following events may result in under-provisioned networks. For example, link failures and/or switch failures, switch misconfiguration and/or an under-provisioned network(s) due to scalability challenges may also result in under-provisioned networks.

Such scenarios may result in congestion causing packet drops resulting in higher tail latencies and job completion times. Various techniques have been proposed and have been implemented in existing data centers/systems. Some of these existing techniques which may have drawbacks are described below.

Bypassing a failed link via a switch configuration or by the use of switch based link aggregation. In this regard, a switch may be configured to not route traffic on links which are not detected and hence re-hashing equal cost multi pathing (ECMP) and re-routing packets on other healthy links.

However, these existing techniques may not solve the problem when the switch itself is faulty or the link is not completely down but under-provisioned causing blockages in a network. Rehashing of flows into another link at the switch level may result in flow collisions. Network endpoints may be unaware of the flow collisions and most often due to hashing, the network endpoints may be unable to precisely isolate the affected flows in a timely manner. Any detection and reconfiguration of the switch routing tables may take significant time (e.g., order of multiple seconds).

Using probes to detect network failures and isolate network faults may also be ineffective. Once the fault is detected, isolation may be achieved from the network and retry of the entire or a part of the existing workload using the healthy network may be achieved. Detection and migration takes significant time (e.g., order of multiple seconds). In many existing scenarios, isolation of the faults may not be trivial and hence remediation may take significant time.

In view of the drawbacks above regarding existing scenarios/systems, some examples of the present disclosure are provided that may adapt to a partially unhealthy network and may bypass failure hotspots (e.g., links, switches, etc.). Breaking larger network path traffic flows into several smaller network path traffic flows may enable the examples of the present disclosure to spread the traffic uniformly over the entire fabric. Breaking larger network path traffic flows into several smaller network path traffic flows to spread the traffic uniformly over the entire fabric may allow a network to make progress despite congestion blockages on some network traffic paths. Additionally, the examples of the present disclosure may detect/discover these congestion blockages and may recover blocked traffic by migrating the blocked traffic onto healthy network traffic flows.

The state of each of the available network traffic flows/paths may be maintained by an arbiter tracking the one or more states as part of the transport reliability layer. In an instance in which the arbiter detects a path is blocked, the arbiter may avoid scheduling packets on the blocked network path(s) and may prioritize a path(s) having more available space/bandwidth for network traffic flow.

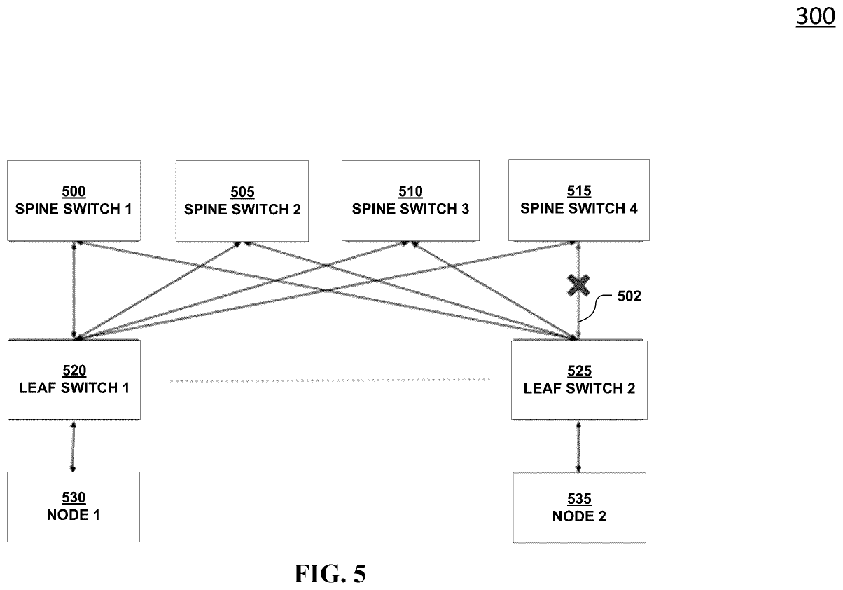

Referring now to FIG. 5, an exemplary network topology is provided according to an example of the present disclosure. For purposes of illustration and not of limitation, as an example, the network topology of FIG. 5 may include two tiers of switches (e.g., leaf switches and spine switches) and one or more nodes. In some examples, the spine switch 1 500, spine switch 2 505, spine switch 3 510, spine switch 4 515 and leaf switch 1 520 and leaf switch 2 525 may, but need not, be examples of one or more of communication devices 105, 110, 115, 120. In other examples, the spine switch 1 500, spine switch 2 505, spine switch 3 510, spine switch 4 515 may be examples of CTSWs and the leaf switch 1 520 and leaf switch 2 525 may be examples of RTSWs. Additionally, node 1 530 and node 2 535 may, but need not, be examples of computing device 200 (e.g., network device 160, computing system 400).

In the example of FIG. 5, the network topology may include a link failure 502 between spine switch 4 515 and leaf switch 1 525. In an instance in which the traffic flow follows the path Node 1 530->Leaf Switch 1 520->Spine Switch 4 515->Leaf Switch 2 525->Node 2 525 (also referred to herein as “data flow path 4)”), the network traffic may be disrupted due to the link failure 502.

The techniques and mechanisms of the present disclosure may help the network workload tolerate one or more failures (e.g., link failures) as follows. For instance, the examples of the present disclosure may provide increased entropy by breaking the larger flows (e.g., larger network traffic paths) into smaller flows (e.g., smaller network traffic paths) to completely utilize the network fabric. Additionally, the examples of the present disclosure may provide weighted path arbitration techniques that may avoid blockages (e.g., congestion blockages) in, or associated with, paths (e.g., network paths) and may prioritize fast moving paths and available/free paths. Furthermore, the examples of the present disclosure may provide path failover techniques that may allow migration of blocked paths onto available/free uncongested paths or new paths to balance blocked (e.g., congested) traffic.

### Increased Entropy

By utilizing a per-packet load balancing technique(s), the examples of the present disclosure may enable breaking down a large network traffic flow into several smaller traffic flows to utilize all the different paths available in, or associated with, a network (e.g., network 140). In the above described example regarding the path Node 1 530->Leaf Switch 1 520->Spine Switch 4 515->Leaf Switch 2 525->Node 2 525, the examples of the present disclosure may determine and enable smaller flows along the path Node 1 530->Leaf Switch 1 520->Spine Switch 1 500->Spine Switch 2 505->Spine Switch 3 510->Leaf Switch 2 525->Node 2 525 as well, for example, such that the network traffic may not get blocked by spine switch 4 515 since there is a link failure 502 between spine switch 4 515 and leaf switch 2 525. The link failure 502 between spine switch 4 515 and leaf switch 2 525 may cause jitter. The jitter may cause latency such as an undesirable delay in the transmission of the network traffic (e.g., packet-based network traffic) across a network.

The examples of the present disclosure may facilitate avoiding/minimizing this jitter by enabling the traffic associated with a detected blocked path to be reassembled and transferred, for example by one or more switches that may be in a different sequence with respect to the switches initially designated to transfer the same traffic via the blocked path such that the traffic may be transmitted to a receiver (e.g., node 2 535).

In some examples, determining and enabling smaller flows along the path in response to detecting a blocked path, may not alone solve the problem of network traffic packets which may be stuck in-flight on a blocked path. As such, the examples of the present disclosure may utilize weighted arbitration techniques and/or path failover techniques, described more fully below to solve problems associated with the network traffic packets which may be stuck in-flight on, or associated with, a blocked path(s).

### Weighted Path Arbitration

The examples of the present disclosure may adapt to a partially unhealthy network and may enable bypassing link failures, switch failures and/or switch misconfigurations that may be present in a network (e.g., network 140).

An arbiter (e.g., arbiter 216, arbiter 98), on node 1 530 (and/or node 2 535) of the examples of the present disclosure may utilize a weighted arbiter technique to assign the above mentioned smaller traffic flows onto one or more determined available paths. The arbiter may maintain the state for each of the detected available network traffic flows as a tracker of the states as part of the transport reliability layer. The arbiter may keep track of all the outstanding packets on a particular traffic flow(s) (e.g., mapped to specific network paths) and may retransmit packets which may not be acknowledged by a receiver (e.g., node 2 535). The arbiter may facilitate tracking on a flow(s)/path(s) and may enable the examples of the present disclosure to make progress regarding transmission of network traffic across the network independently in a non-blocking manner. In an instance in which the arbiter detects/determines a path(s) is blocked (for example, by detecting many un-acked packets), the arbiter may avoid scheduling packets on the detected blocked path(s) and may prioritize a determined path having more space/bandwidth availability to transfer network traffic.

The arbiter (e.g., arbiter 216, arbiter 98) of node 1 530, for example, may determine that there is some condition (e.g., network congestion, blockage), associated with a designated network path/flow for transfer of traffic (e.g., a tracking window). In this regard, the arbiter may determine that one or more packets associated with the network traffic may not be moving as fast on this particular network path/flow. As such, the arbiter may prioritize/rank other detected available network paths/flows and may move/transfer these packets to one of these detected available network paths/flows to enable delivery of the packets to a receiver (e.g., node 2 535). By prioritizing/ranking the available network paths (i.e., weighted part arbitration) to move/transfer the packets for delivery to a receiver, the arbiter may keep the packets moving and avoid blockages (e.g., congestion) associated with one or more paths in the network (e.g., network 140).

The arbiter may keep track of tracker windows for each of the determined available network flows. For purposes of illustration and not of limitation, for example, consider that there is one flow path 1) associated with Node 1 530->Leaf Switch 1 520->Spine Switch 1 500->Leaf Switch 2 525->Node 2 525, another flow path 2) associated with Node 1 530->Leaf Switch 1 520->Spine Switch 2 505->Leaf Switch 2 525->Node 2 525, another flow path 3) associated with Node 1 530->Leaf Switch 1 520->Spine Switch 3 510->Leaf Switch 2 525->Node 2 525. As such, each of these three flow paths may correspond to a tracker window being tracked by the arbiter. When a packet(s) is sent, along a path, the arbiter may determine the tracker window is moving. In an instance in which the arbiter detects a fault associated with a flow path, a congestion may build-up on one of the flows paths, and as such the tracker window associated with the flow path having the fault may not move as easily as the other tracker windows. In the example of FIG. 5 for instance the arbiter determined that it was unable to schedule packets, or to continue transfer, on the blocked tracker window associated with the blocked flow path associated with spine switch 4 515.

For purposes of illustration and not of limitation, for example, consider an instance in which the arbiter (e.g., arbiter 216, arbiter 98) scheduled packets one through ten to be transmitted across flow/path Node 1 530->Leaf Switch 1 520->Spine Switch 4 515->Leaf Switch 2 525->Node 2 525 (e.g., data flow path 4)) that failed due to link failure 502 associated with spine switch 4 515. In this regard, suppose that packets 1, 2, 3, 4, 5, 6, and 7 were transmitted on this path (e.g., data flow path 4)) and then an associated link (e.g., link 150) went down i.e., failed (e.g., link failure 502). In this regard, packets 8, 9 and 10 were unable to be transmitted across this path. As such, the arbiter may arbitrate between the flow path 1), flow path 2) and flow path 3) which may be available and unblocked, as described above, to select one of the three flow paths to transmit packets 8, 9, 10 to a receiver (e.g., node 2 535) since the arbiter may have determined that the packets 8, 9 and 10 are not moving on the initially designated flow path (e.g., data flow path 4)) associated with the link failure 502 between spine switch 4 515 and leaf switch 2 525.

Additionally, for purposes of illustration and not of limitation, for example, consider a scenario in which the arbiter (e.g., arbiter 216, arbiter 98) identified four flow paths (e.g., flow paths A, B, C, D) that are available and operating properly (e.g., to facilitate transmission of network traffic). In this regard, the arbiter may allocate 25% of network traffic to be transmitted across the network (e.g., network 140) to the flow path A, 25% to the flow path B, 25% to the flow path C, and 25% to the flow path D in this example. Suppose further that the arbiter determines that one of the four flow paths (e.g., flow path D) fails or stops functioning properly. In this manner, the arbiter may now reallocate the prioritizations/weightings of the four flow paths such as for example 33% of network traffic to be transmitted to the flow path A, 33% to the flow path B, 33% to the flow path C and 0% to the flow path D since the flow path D failed or is not functioning properly in this example. In other words, the prioritizations/weightings effectively of the 3 functioning flow paths (e.g., flow paths A, B, C) now becomes about 33%, 33% and 33% respectively.

In other examples, the weights assigned to the different flow paths need not be evenly distributed. For instance, in the above example the arbiter may assign the weights as 10% of network traffic to be transmitted to the flow path A, 45% to the flow path B, and 45% to the flow path C (and 0% to flow path D), or may allocate the weights to the functioning flow paths in another suitable matter (e.g., totaling approximately 100%).

### Path Failover

In some examples, the arbiter may determine that there is a failure associated with a flow path based on a predetermined time period expiring and/or based on one or more predetermined number (e.g., greater than n times) of retransmission attempts. For example, in response to the arbiter determining that a receiver (e.g., node 2 535) designated to receive designated network traffic (e.g., packets) has not received the network traffic during the predetermined time period and that the arbiter has attempted to resend, to the receiver, the network traffic that was not prior transferred to the receiver on the initially designated path, the arbiter may then determine that the originally designated path failed and that the network traffic (e.g., packets) may be lost and may need recovering. In this manner, the arbiter may remedy a blocked path(s) associated with a network and all, or a portion of, the outstanding packets scheduled on the blocked path(s).

In some other examples of the present disclosure if for a path, a contiguous series of packets are repeatedly retransmitted over a predetermined threshold (e.g., greater than n times), the arbiter may mark the path as failed. The detection, by the arbiter, for this retransmission of contiguous series of packets may occur at a multiple of round trip time (RTT) scale and may be in the order of microseconds to low milli-seconds. The sensitivity of a path failure may be controlled, by the arbiter, based on the number of contiguous packets being retransmitted and the number of times the contiguous packets may need to be retransmitted before marking the path as failed by the arbiter.

The examples of the present disclosure may implement various approaches to facilitate failover techniques. First, the examples of the present disclosure may enable migration of outstanding packets to facilitate failover. Since, a transmitter (e.g., node 1 530) may be unaware whether the network traffic (e.g., packets) on a path have been acknowledged or not, the transmitter may retransmit those packets (e.g., packets 8, 9, 10 described above) on another healthy path (e.g., flow path 1), flow path 2), and/or flow path 3) described above). A receiver (e.g., node 2 535) may then need to identify these received packets (e.g., packets 8, 9, 10). In this regard, the receiver may determine if it has these received packets and may communicate with the transmitter to inform the transmitter if it has these received packets (e.g., packets 8, 9, 10). In an instance in which the received packets are identified as duplicates, the received packets may be dropped immediately. In other words, if all the packets (e.g., traffic) have been received by the receiver (e.g., node 2 535) but were prior unacknowledged for some reason by the receiver to the transmitter (e.g., the acknowledgements from the receiver may be dropped/lost) and if the packets were retransmitted to the receiver and received by the receiver these packets may be duplicates. As such these packets may need to be marked as duplicates by the receiver (e.g., the arbiter of node 2 535). In response to the receiver marking the packets as duplicates the packets may be dropped (e.g., deleted/removed) rather than stored again to a memory (e.g., RAM 82) which may cause corruption.

On the other hand, in an instance in which the receiver (e.g., the arbiter of the node 2 535) determines that the packets (e.g., packets 8, 9, 10) are newly received and were not prior saved to the memory, the receiver may mark these received packets as unique and may store these received packets to the memory (e.g., RAM 82).

Second, the examples of the present disclosure may enable reclaiming of resources associated with a failed path(s) to facilitate failover. In this regard, the transmitter (e.g., the arbiter of the node 1 530) may remove the failed path(s) such as, for example, the path Node 1 530->Leaf Switch 1 520->Spine Switch 4 515->Leaf Switch 2 525->Node 2 525 (e.g., data flow path 4)) that failed due to link failure 502 associated with spine switch 4 515 in FIG. 5. By removing the failed path, the arbiter (e.g., arbiter 216, arbiter 98) of the transmitter (e.g., node 1 530) may avoid retransmitting failed packets repeatedly. The arbiter of the transmitter may send a signal to the receiver (e.g., node 2 535) to perform a cleanup of a failed path(s) via a control channel (e.g., via a healthy path (e.g., flow path 1), flow path 2), flow path 3)). Any degradation of performance of the network that occurs due to the failed path(s) may be linearly proportional to the available bandwidth and in some examples may be determined by the arbiter of the transmitter.

For example, if the transmitter determines that data flow path 4) failed and is not making any progress regarding transmission of packets, the arbiter of the transmitter may reclaim the resources associated with data flow path 4), and the transmitter may accordingly communicate with the receiver to inform the receiver to reclaim the resources associated with data flow path 4), such that the memory (e.g., RAM 82) may be reused for another separate flow path (e.g., data path flow 1), data path flow 2), etc.).

In some examples, the resources being reclaimed may be the memory state associated with the failed flow path (e.g., data flow path 4), such as for example the tracker windows associated with the failed flow path stored on the transmitter (e.g., node 1 530). For instance, the transmitter may be keeping track of all or a subset of outstanding packets that may not have been received by the receiver. Consider for example that a memory (e.g., RAM 82) of the transmitter, or the receiver, is chunked into four sections/areas. In this regard, as an example, 25% of that memory may be designated for the failed flow path (e.g., data flow path 4), which may no longer be used by the transmitter, or the receiver. As such, the 25% of the memory of the transmitter/receiver may be reclaimed and may be allocated by the arbiter of the transmitter/receiver to other existing paths, or the arbiter may create/generate a new separate flow path (e.g., flow path 5)) and as an example may allocate the 25% of the memory to the new separate flow path. As such, the transmitter (and/or the receiver) may, for example, reclaim the unused memory space associated with the failed flow path and may allocate the unused memory space to another existing flow path or to a new (e.g., newly created) flow path.

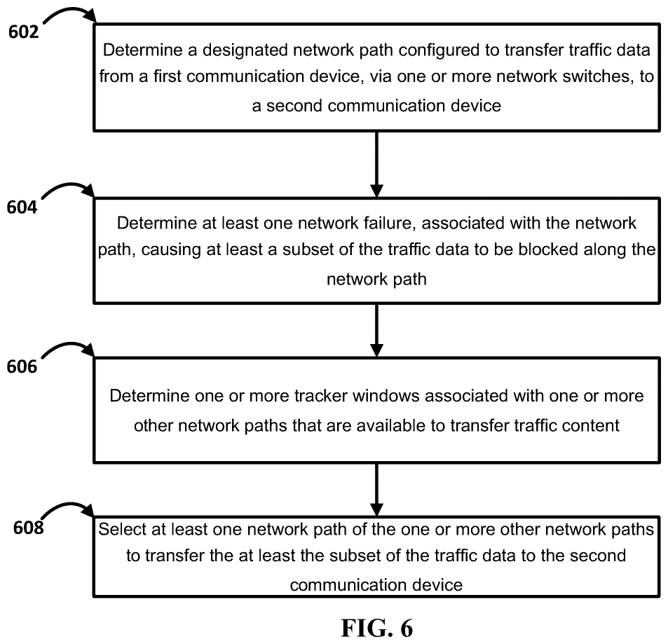

FIG. 6 illustrates an example flowchart illustrating operations for adapting to a partially unhealthy network and bypassing failures associated with the network according to examples of the present disclosure. At operation 602, a device (e.g., a first communication device (e.g., node 1 530, computing device 200)) may determine a designated network path (e.g., data flow path 4)) configured to transfer traffic data from the device, via one or more network switches, to a second communication device (e.g., node 2 535). The traffic data may include one or more packets. At operation 604, a device (e.g., node 1 530, computing device 200) may determine at least one network failure, associated with the network path, causing at least a subset of the traffic data to be blocked along the network path. In some examples, the network failure may be at least one of a link failure (e.g., link failure 502), a network switch failure (e.g., a failure associated with one or more of leaf switch 1 520, spine switch 1 500, spine switch 2 505, spine switch 3 510, spine switch 4 515, leaf switch 2 525), or a network switch misconfiguration.

At operation 606, a device (e.g., node 1 530, computing device 200) may determine one or more tracker windows associated with one or more other network paths that are available to transfer traffic content. In some examples, the one or more other network paths may, but need not, be data flow path 1), data flow path 2), data flow path 3), described above. In some examples, determining (e.g., by an arbiter) of the one or more tracker windows may include determining that the one or more other network paths are transferring other traffic content (e.g., other packets) across a network (e.g., network 140) associated with the designated network path. At operation 608, a device (e.g., node 1 530, computing device 200) may select at least one network path of the one or more other network paths to transfer at least the subset of the traffic data (e.g., packets 8, 9, 10 described above) to the second communication device. In some examples, the arbiter (e.g., arbiter 216, arbiter 98) of the device may select the at least one network path of the one or more other network paths to transfer the subset of the traffic data to the second communication device.

In some examples, the device (e.g., node 1 530, computing device 200) may assign one or more priorities or weightings, to the one or more other network paths, comprising designating one or more percentages, to the one or more other network paths, indicating at least one percentage (e.g., 25%, etc.) associated with the one or more other network paths to transfer network traffic content across a network. In some other examples, the device (e.g., node 1 530, computing device 200) may reassign the priorities or weightings (e.g., 33%, etc.) in response to determining at least one failure associated with the at least one network path of the one or more other network paths. Additionally in some examples, the device (e.g., node 1 530, computing device 200) may migrate at least the subset of the traffic data (e.g., packets 8, 9, 10 described above) to the at least one network path to transfer at least the subset of the traffic data to the second communication device.

In some examples, the device (e.g., node 1 530, computing device 200) may reclaim one or more resources (e.g., a subset of memory (e.g., RAM 82)) associated with the at least one network failure that is associated with the network path that failed (e.g., data flow path 4)). In this regard, the device may reallocate the one or more resources to the one or more other network paths (e.g., data flow path 1), data flow path 2), etc.) or one or more newly generated network paths (e.g., data flow path 5)).

### B. Providing a Scheduler for Central Processing Unit Engines Utilized for Hardware Offloaded Artificial Intelligence Machine Learning Workloads

### Technical Field

The examples of the present disclosure may relate generally to methods, apparatuses and computer program products for high performance artificial intelligence (AI) and machine learning (ML) transport of data associated with Remote Direct Memory Access (RDMA) transport communication devices utilized in networks.

### Background

High performance AI transport may typically be implemented in hardware to accelerate application performance. However, implementing high performance AI transport entirely in hardware may result in lack of scalability for evolving workloads.

Therefore, there may be a need to enhance AI transport control scalability associated with high-performance AI/ML applications.

### Brief Summary

Some examples of the present disclosure may relate to mechanisms for providing a hardware based scheduler for central processing unit (CPU) micro engines utilized for AI transport control and/or ML transport control scalability. The AI transport and/or ML transport may be targeted for RDMA data movement for collective communication for high performance AI applications/ML applications utilized in RDMA transport (e.g., RDMA over Converged Ethernet (RoCE)) communication devices (e.g., endpoints).

Some examples of the present disclosure may also provide a scalable scheduler that may provide coupling between hardware offloaded processing and CPU core micro engines.

A system for scheduling one or more central processing units to facilitate requests for processing is provided. The system may receive one or more requests to perform processing associated with one or more tasks. The system may determine availability of a plurality of central processing units to perform the processing. The system may select at least one central processing unit, from the plurality of central processing units, to perform the processing. The system may enable provision of the one or more requests to the selected at least one central processing unit to process the one or more tasks.

### Description

### Exemplary System Architecture

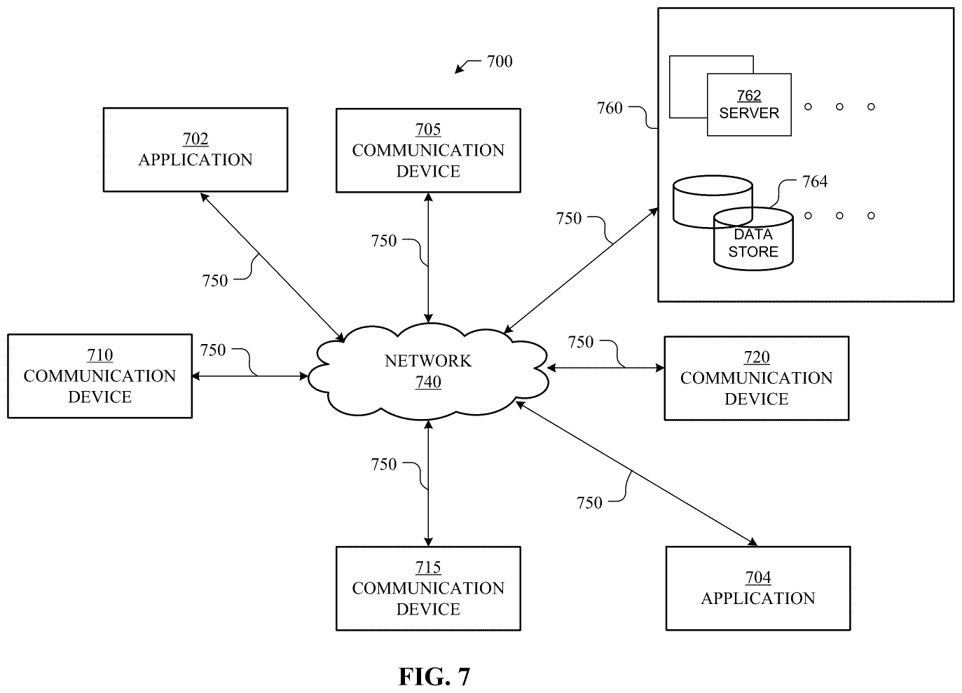

Reference is now made to FIG. 7, which is a block diagram of a system according to exemplary embodiments. As shown in FIG. 7, the system 700 may include one or more communication devices 705, 710, 715 and 720, one or more applications 702, 704 and a network device 760. Additionally, the system 700 may include any suitable network such as, for example, network 740. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 740 may include one or more networks 740.

Links 750 may connect the communication devices 705, 710, 715 and 720 to network 740, network device 760 and/or to each other. This disclosure contemplates any suitable links 750. In some exemplary embodiments, one or more links 750 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 750 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 750, or a combination of two or more such links 750. Links 750 need not necessarily be the same throughout system 700. One or more first links 750 may differ in one or more respects from one or more second links 750.

In some examples of the present disclosure, communication devices 705, 710, 715, 720 may be electronic devices including hardware, software, or embedded logic components or a combination of two or more such components and capable of carrying out the appropriate functionalities implemented or supported by the communication devices 705, 710, 715, 720. The communication devices 705, 710, 715, 720 may be any kind/type of AI/ML accelerator, such as for example graphics processing units (GPUs). The communication devices 705, 710, 715, 720 may include or be associated with a network interface card (NIC) configured to implement an RDMA engine for performing RDMA communications. The RDMA engine may be based on a networking protocol that allows RDMA over an Ethernet network (referred to as RDMA over Converged Ethernet or RoCE), which may be on the Ethernet level or the Internet level. In some examples, the communication devices 705, 710, 715, 720 may be network switches (e.g., network switch devices). For instance, in some examples the communication devices 705, 710, 715, 720 may be one or more switches capable of transmitting and/or receiving data between each other and other switches and/or other devices.

In some examples of the present disclosure, the applications 702, 704 may be AI applications and/or ML applications configured to facilitate RDMA data transport across the network 740. In some other examples, the applications 702, 704 may be any other suitable applications. Additionally, in some examples, the applications 702, 704 may be upper layer applications. The applications 702, 704 may include software, computer program code and/or embedded logic components or a combination of two or more such components and may be capable of carrying out the appropriate functionalities implemented or supported by the applications 702, 704.

In other examples of the present disclosure, as an example, and not by way of limitation, the communication devices 705, 710, 715, 720 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 705, 710, 715, 720 may enable one or more users to access network 740. The communication devices 705, 710, 715, 720 may enable a user(s) to communicate with other users at other communication devices 705, 710, 715, 720.

Network device 760 may be accessed by the other components of system 700 either directly or via network 740. As an example and not by way of limitation, communication devices 705, 710, 715, 720 may access network device 760 using a web browser or a native application associated with network device 760 (e.g., a mobile social-networking application, a messaging application, another suitable application, or any combination thereof) either directly or via network 740. In particular exemplary embodiments, network device 760 may include one or more servers 762. Each server 762 may be a unitary server or a distributed server spanning multiple computers or multiple datacenters. Servers 762 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 762 may include hardware, software, or embedded logic components or a combination of two or more such components for carrying out the appropriate functionalities implemented and/or supported by server 762. In particular exemplary embodiments, network device 760 may include one or more data stores 764. Data stores 764 may be used to store various types of information. In particular exemplary embodiments, the information stored in data stores 764 may be organized according to specific data structures. In particular exemplary embodiments, each data store 764 may be a relational, columnar, correlation, or other suitable database. Although this disclosure describes or illustrates particular types of databases, this disclosure contemplates any suitable types of databases. Particular exemplary embodiments may provide interfaces that enable communication devices 705, 710, 715, 720 and/or another system (e.g., a third-party system) to manage, retrieve, modify, add, or delete, the information stored in data store 764.

In some examples, the network device 760 may be one or more transmitter entities, receiver entities, nodes, network switches, servers (e.g., network servers) and/or the like. For instance, the network device 760 may be one or more transmitter entities, receiver entities, nodes, switches, servers and/or the like that establish a connection (e.g., via wide area network (WAN), local area network (LAN), etc.) between one or more communication devices 705, 710, 715, 720 and/or between one or more applications 702, 704. For example, the network device 760 may be a node that connects the communication devices 705, 710, 715, 720 so that they may communicate with each other and any other communication devices (e.g., other nodes), or entities such as for example applications 702, 704, that are connected to, or associated with the same network device 760 (e.g., directly or indirectly).

In some other examples of the present disclosure, the network device 760 may provide users of the system 700 the ability to communicate and interact with other users. In particular exemplary embodiments, network device 760 may provide users with the ability to take actions on various types of items or objects, supported by network device 760. In particular exemplary embodiments, network device 760 may be capable of linking a variety of entities. As an example and not by way of limitation, network device 760 may enable users to interact with each other as well as receive content from other systems (e.g., third-party systems) or other entities, or to allow users to interact with these entities through an application programming interfaces (API) or other communication channels.

It should be pointed out that although FIG. 7 shows one network device 760 and four communication devices 705, 710, 715 and 720 and two applications 702, 704 any suitable number of network devices 760, communication devices 705, 710, 715 and 720 and applications 702, 704 may be part of the system of FIG. 7 without departing from the spirit and scope of the present disclosure.

### Exemplary Computing Device

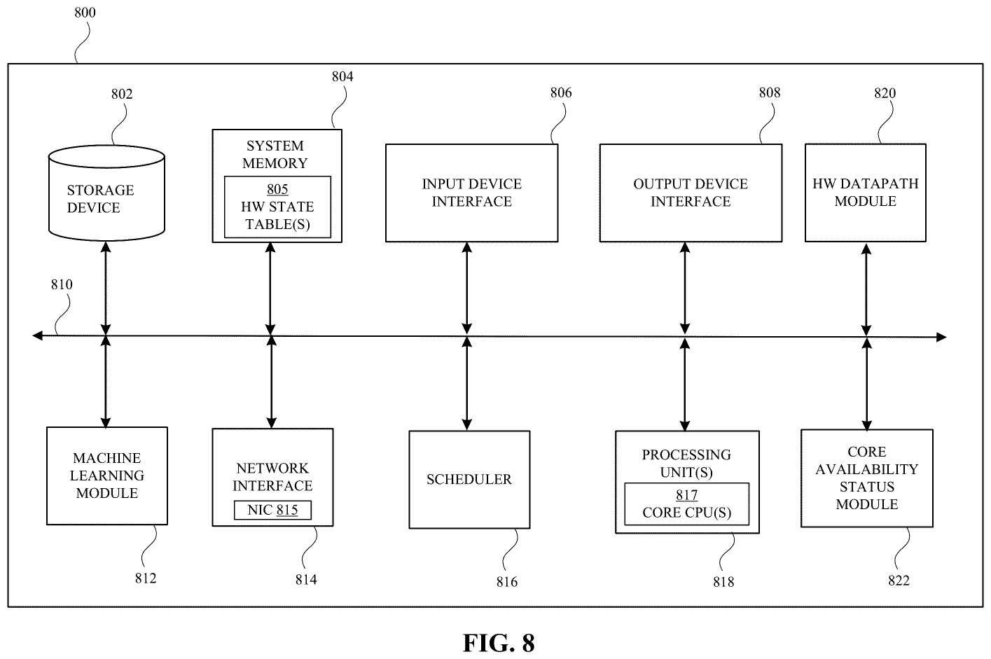

FIG. 8 illustrates an example computing device 800, in accordance with one or more examples of the present disclosure. In some examples, the computing device 800 may be an example of network device 760. The computing device 800 may be, and/or may be a part of, an accelerator for AI/ML applications (e.g., GPUs, field-programmable gate arrays (FPGAs), application-specific integrated circuits (ASICs)). The computing device 800 may include various types of computer-readable media and interfaces for various other types of computer-readable media. The computing device 800 includes a bus 810, a system memory 804 that may include a hardware (HW) state table(s) 805, a storage device 802, an input device interface 806, an output device interface 808, a machine learning module 812, a network interface 814, a scheduler 816, a HW datapath module 820, a core availability status module 822, and a processing unit(s) 818, or subsets and variations thereof. The processing unit(s) 818 may include, or be associated with, one or more central processing units (CPUs) 817 (also referred to herein as core CPU(s) 817 or core CPUs 817). In this regard, in some examples, the CPUs 817 may be embodied within the processing unit(s) 818. In some other examples, the CPUs 817 may be located external to the processing unit(s) 818. Not all depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The bus 810 collectively represents all system, peripheral, and chipset buses that communicatively connect the numerous internal devices of the computing device 800. In one or more embodiments, the bus 810 communicatively connects the processing unit 818 with the other components of the computing device 800. From various memory units, the processing unit 818 retrieves instructions to execute and data to process in order to execute the operations of the subject disclosure. The processing unit 818 may be a controller and/or a single or multi-core processor or processors in various embodiments.

The storage device 802 may be a read-and-write memory device. The storage device 802 may be a non-volatile memory unit that stores instructions and data (e.g., static and dynamic instructions and data) even when the computing device 800 is off. In one or more embodiments, a mass-storage device (such as a magnetic or optical disk and its corresponding disk drive) may be used as the storage device 802. In one or more embodiments, a removable storage device (such as a floppy disk, flash drive, and its corresponding disk drive) may be used as the storage device 802.

Like the storage device 802, the system memory 804 may be a read-and-write memory device. However, unlike the storage device 802, the system memory 804 may be a volatile read-and-write memory, such as random-access memory. The system memory 804 may store any of the instructions and data that one or more processing units 818 may need at runtime to perform operations. In one or more example embodiments, the processes of the subject disclosure may be stored in the system memory 804 and/or the storage device 802. From these various memory units, the one or more processing units 818 may retrieve instructions to execute and data to process in order to execute the processes of one or more embodiments, discussed below. As described above, the system memory 804 may include one or more HW state tables 805. The HW state table(s) 805 may store one or more unique identifiers (ids) and/or states associated with corresponding work requests. The work requests may be originated from and generated by one or more applications (e.g., applications 702, 704) and/or one or more entities (e.g., communication devices 705, 710, 715, 720). The HW state table(s) 805 may also store any other suitable data, content and/or the like. Additionally, the system memory 804 may include one or more buffers. Buffers for RDMA applications may include send queues, receive queues, completion queues, work queue elements (e.g., work-descriptor queue elements), completion queue elements, and/or the like.

Embodiments within the scope of the present disclosure may be partially or entirely realized using a tangible computer-readable storage medium (or multiple tangible computer-readable storage media of one or more types) encoding one or more instructions. The tangible computer-readable storage medium also may be non-transitory in nature.

The computer-readable storage medium may be any storage medium that may be read, written, or otherwise accessed by a general purpose or special purpose computing device, including any processing electronics and/or processing circuitry capable of executing instructions. For example, without limitation, the computer-readable medium may include any volatile semiconductor memory (e.g., the system memory 804), such as RAM, DRAM, SRAM, T-RAM, Z-RAM, and TTRAM. The computer-readable medium also may include any non-volatile semiconductor memory (e.g., the storage device 802), such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium may include any non-semiconductor memory, such as optical disk storage, magnetic disk storage, magnetic tape, other magnetic storage devices, or any other medium capable of storing one or more instructions. In one or more embodiments, the tangible computer-readable storage medium may be directly coupled to a computing device, while in other embodiments, the tangible computer-readable storage medium may be indirectly coupled to a computing device, e.g., via one or more wired connections, one or more wireless connections, or any combination thereof.

Instructions may be directly executable or may be used to develop executable instructions. For example, instructions may be realized as executable or non-executable machine code or as instructions in a high-level language that may be compiled to produce executable or non-executable machine code. Further, instructions also may be realized as or may include data. Computer-executable instructions also may be organized in any format, including routines, subroutines, programs, data structures, objects, modules, applications, applets, functions, etc. As recognized by those of skill in the art, details including, but not limited to, the number, structure, sequence, and organization of instructions may vary significantly without varying the underlying logic, function, processing, and output.

While the above discussion primarily refers to microprocessors or multi-core processors that execute software, one or more embodiments are performed by one or more integrated circuits, such as ASICs or FPGAs. In one or more embodiments, such integrated circuits execute instructions that are stored on the circuit itself.

The bus 810 also connects to the input device interface 806 and output device interface 808. The input device interface 806 enables the system to receive inputs. For example, the input device interface 806 allows a user to communicate information and select commands on the computing device 800. The input device interface 806 may be used with input devices such as keyboards, mice, dials, switches, sliders, and other interfaces (physical or virtual) for a user to supply information to the computing device 800. The output device interface 808 may be used with output devices such as displays, speakers, and other interfaces (physical or virtual) for the computing device 800 to provide information. One or more example embodiments may include devices that function as both input and output devices, such as a touchscreen.

The computing device 800 may also contain a machine learning module 812. The machine learning module 812 may be a hardware and/or software module that includes machine learning logic. Machine learning logic may be embodied in the form of computer-readable instructions and may include representation learning, feature learning, convolutional neural networks, artificial neural networks, graph neural networks, attention models, image recognition models, and/or the like. The machine learning module 812 may include one or more accelerators for AI/ML applications. The accelerators may be a GPU, FPGA, ASIC, and/or the like.

The bus 810 also couples the computing device 800 to one or more networks and/or to one or more network nodes through the network interface 814. The network interface 814 may include one or more interfaces that allow the computing device 800 to be a part of a network of computers (e.g., a local area network (LAN), a wide area network (WAN), or a network of networks (the Internet)). For example, the network interface 814 may include a network interface card (NIC) 815. In one or more implementations, the NIC 815 may be associated with one or more accelerators of the machine learning module 812.

In some examples, the HW datapath module 820 may be a hardware device configured to determine whether a selected core CPU 817, from among a set of core CPUs 871, has completed the processing of a work request(s) received by the scheduler 816 and may provide a message to the scheduler 816 indicating the completion of the work request(s).

The core availability status module 822 may be a hardware device and/or a software module that may include logic (e.g., machine learning logic), or a combination thereof. In some examples, the core availability status module 822 may include one or more status registers indicating whether the core CPUs 871 are available (or busy) to facilitate processing of one or more work requests received by the scheduler 816, for example from an application (e.g., applications 702, 704) and/or an entity (e.g., communication devices 705, 710, 715, 720).

As described above, the computing device 800 may also include the scheduler 816. In some examples, the scheduler 816 may be a hardware device. In other examples, the scheduler 816 may be a hardware device and/or a software module that may include logic (e.g., machine learning logic). The scheduler 816 may check the availability of one or more of the core CPUs 817 to select a core CPU 817 from among the provisioned set of the core CPUs 817 in which a work request(s) may be dispatched to/received by the scheduler 816. The work request(s) may be scheduled, by the scheduler 816, based on a work request(s) generated by an application(s) or other entity to perform a task(s) or function(s). This orchestration of work requests scheduling by the scheduler 816 may enable scaling of the processing of work requests on demand by one or more applications and/or by one or more entities. The processed work requests may initiate offload operations/processing regarding an associated datapath, while still being tracked based on a unique identifier for example. Once processing regarding a work request(s) is fully completed, a completion descriptor (CD) indicator to indicate the completion of the work request may be generated, by the scheduler 816, and may be sent to an application(s) (e.g., application 702, application 704), or other entity (e.g., communication devices 705, 710, 715, 720), that requested the work request. In one or more implementations, the scheduler 816 may be associated with one or more accelerators of the machine learning module 812 and/or the network interface 814.

### Exemplary System Operation

High performance AI transport may typically be implemented in hardware to accelerate application performance. However, implementing high performance AI transport entirely in hardware may result in lack of scalability for evolving workloads.

To ameliorate this, the examples of the present disclosure may provide multiple CPUs (also referred to herein as CPU cores) that may be integrated into a hardware data processing pipeline that may provide scaling of workloads. Some beneficial aspects of the examples of the present disclosure may involve providing a system that has a scheduler (e.g., an accelerator) to offload (e.g., computation intensive) stateful lookups from one or more CPU cores, and may enforce any ordering dependencies and enable dataset placement into different memory hierarchies depending/based on performance needs. Having these CPU cores as stateless and workload agnostic engines may enable better scalability by the examples of the present disclosure.

The examples of the present disclosure may provide solutions/techniques for a scalable scheduler that may provide a coupling between hardware offloaded processing and multiple CPU cores. For instance, the examples of the present disclosure may provide a scheduler for CPU micro engines that may be utilized for AI transport and/or ML transport control. The AI transport and/or ML transport may be implemented for RDMA data movement (e.g., RDMA over converged ethernet) associated with communications regarding high performance AI applications/ML applications utilized in, or associated with, network endpoints (e.g., transmitter devices, receiver devices) associated with, for example, data centers.

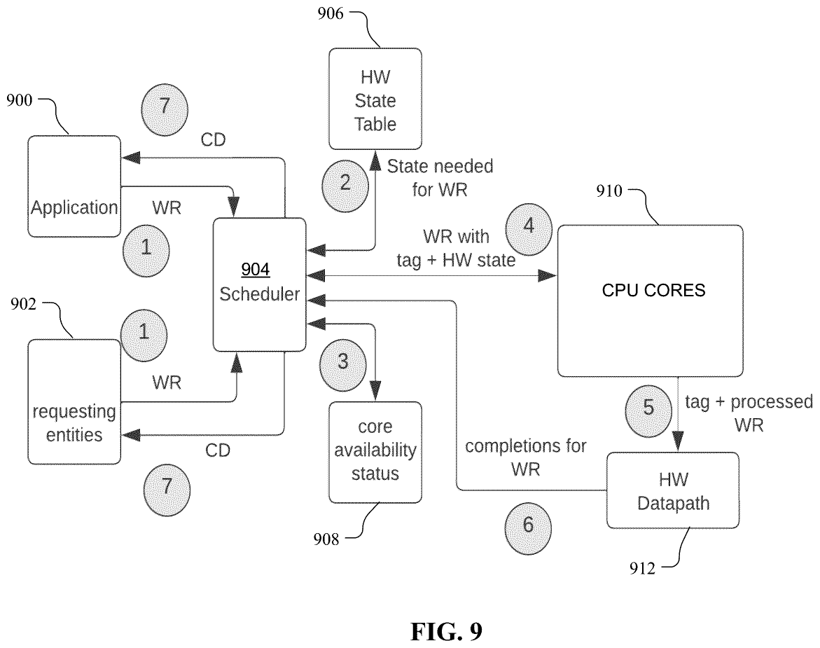

Referring now to FIG. 9, a diagram illustrating an exemplary system and exemplary process for scheduling one or more central processing units to facilitate requests from one or more applications and/or one or more entities is provided according to examples of the present disclosure. At operation 1, one or more work requests may be initiated by one or more applications 900 and/or one or more requesting entities 902. For purposes of illustration and not of limitation, for example, the application(s) may be an upper layer application(s). In some examples, the application(s) 900 may be examples of applications 702, 704 and the one or more requesting entities 902 may be examples of communication devices 705, 710, 715, 720. In some examples, the application(s) 900 may be a communication library associated with AI tasks and/or ML tasks corresponding to an accelerator and/or a GPU. In this regard, the application(s) 900 may be capable of generating requests (e.g., work requests) associated with the AI tasks and/or ML tasks that may need to be performed.

The work requests (WRs) of FIG. 9 may represent distinct workloads that may need processing by one or more CPU cores 910. The CPU cores 910 may also be referred to herein as CPU micro engines 910 and/or a group/set of N CPU cores 910. In this regard, the CPU cores 910 may be any suitable number N of CPU cores 910. In some examples, the CPU cores 910 may be examples of core CPUs 917. Some of these work requests (e.g., workloads) may originate from upper level software applications (e.g., application(s) 900) and/or some work requests may be initiated as control packets to/from a network (e.g., network 740) by one or more requesting entities (e.g., requesting entities 902), as described above. The scheduler 904 may check the availability of one or more of the CPU cores 910 to process the work requests as the work requests may be received from application(s) 900 and/or the one or more requesting entities 902, as described more fully below. In response to the scheduler 904 scheduling one or more CPU cores 910 to process the work requests, an acknowledgement may be generated by the scheduler 904 and may be provided by the scheduler 904 to the application(s) 900 and/or one or more requesting entities 902 in the form of a completion descriptor, as described more fully below. In some examples, the scheduler 904 may be an example of scheduler 816.

Some of the operations of FIG. 9 may be stateful in nature. For instance, the scheduler 904 may facilitate the assigning of the processing of requests (e.g., work requests) and the dispatching of the workload tasks to the CPU cores 910 such that any stateful processing needed may be self-contained in the request(s).

Consider as an example, for purposes of illustration and not of limitation, that a first work request from the application(s) 900 may be to send a message of 100 kilobytes but to send the message in chunks of 1,000 bytes at time. As another example, consider that a second work request from the application(s) 900 may be a request that message number 500 of 1,000 messages needs to be retransmitted because message number 500 may have been dropped or lost during an initial transmission of message number 500 across a network (e.g., network 740). At operation 2, the scheduler 904 may assign a tag such as, for example, a unique id to the work requests (e.g., the first work request and the second work request, etc.) which may be stored, by the scheduler 904 in the HW state table 906. In some examples, the HW state table 906 may be an example of the HW state table(s) 805.

For instance, at operation 2, as part of the work request dispatch process, each of the work requests received from the application(s) 900 and/or the one or more requesting entities 902 may be first tagged with a unique id, by the scheduler 904, that enables tracking of the work requests, and associated transactions, through firmware and one or more datapath layers. Based on the type of work request, the HW state table 906 may be accessed. One or more items of content (e.g., states) of the HW state table 906 may be provided along with the corresponding unique id to a CPU core 910 among the CPU cores 910 determined, by the scheduler 904, to be available for processing the work request.

For example, the scheduler 904 may analyze the HW state table 906 based on a received work request(s) and may determine information associated with a state(s) corresponding to the work request for one or more tasks associated with the work request to be performed. In the example in which the work request pertained to sending a message of 100 kilobytes, the scheduler 904 may need to determine the destination/location regarding where to send the message of 100 kilobytes. In this regard, the scheduler 904 may analyze the HW state table 906 to determine an IP address where the message of 100 kilobytes may need to be sent as the destination. The scheduler 904 may denote or select the IP address and may provide the IP address (e.g., the state) with the work request and the tag (e.g., unique id) to a CPU core 910 of the group/set of N CPU cores 910 that the scheduler 904 determines is available to process the first work request.

In the example regarding the second work request pertaining to a request for retransmitting message number 500 of 1,000 messages, the scheduler 904 may also assign a tag and may analyze the HW state table 906 to determine a state associated with the second work request. In this example, the state detected from analyzing the HW state table 906 may be the IP address (e.g., the state) pertaining to the destination in which the message number 500 may need to be sent. The scheduler 904 may denote or select this IP address from the HW state table 906 and may provide the IP address with the second work request and the tag (e.g., unique id) to a CPU core 910 of the group/set of N CPU cores 910 that the scheduler 904 determines is available to process the second work request.

At operation 3, in some examples, the scheduler 904 may check the core availability status 908 by reading/analyzing data of one or more status registers of the core availability status 908. The core availability status 908 may also be referred to herein as CPU core availability status 908 or CPU core availability status module 908. In some examples, the core availability status 908 may be an example of the core availability status module 822. The CPU cores 910 may send/transmit messages to the core availability status 908 with indications as to whether the CPU cores 910 are busy (e.g., currently processing other work request(s) or performing other tasks) or available and free to process work requests (e.g., new work requests) received by the scheduler 904. In some examples, the CPU cores 910 may periodically send the messages indicating whether the CPU cores 910 are available or busy to the core availability status 908 and the core availability status 908 may store the indications (e.g., regarding available or busy) in one or more status registers of the core availability status 908. The scheduler 904 may analyze the one or more status registers of the core availability status 908 to determine which CPU cores 910 are available and free and may select a CPU core 910, from among the group/set of N CPU cores 910 to process the work request. In an instance in which the scheduler 904 may determine that multiple CPU cores of the group/set of N CPU cores 910 are available and free, the scheduler 904 may select, of its own choosing, one CPU core 910 from the multiple available CPU cores that are available to process work requests. In an instance in which the scheduler 900 selects a CPU core 910, of the group/set of N CPU cores 910, that is available, the scheduler 904 may assign the work request to the selected available CPU core 910 for processing.

Additionally or alternatively at operation 3, in some other examples, the scheduler 904 may send/transmit one or more messages to the CPU cores 910 requesting an indication as to whether the respective CPU cores 910 are available, and free, to process a work request(s). In response to receipt of the one or more messages from the scheduler, the CPU cores 910 may send/transmit a reply message to the scheduler 904 indicating whether the CPU cores 910 are busy or available to process the work request(s). As such, the scheduler 904 may select a CPU core 910 from the group/set of N CPU cores 910 to process the work request.

At operation 4, in response to selecting a CPU core 910 that is available to process the work request(s), from among the group/set of N CPU cores 910, the scheduler 904 may send/transmit to the selected CPU core 910 a message including the work request, the assigned tag (e.g., the unique id) and the state (e.g., IP address) determined based on analyzing the HW state table 906.

In some other examples, the scheduler 904 may consider the resources needed to perform the processing of the work requests or one or more tasks associated with the work requests when selecting a CPU core 910 from among the group/set of N CPU cores 910. For purposes of illustration and not of limitation, for example, some of the CPU cores 910 may have a large/high processing capacity, and some of the CPU cores 910 may have a medium processing capacity while other CPU cores 910 may have a small/low processing capacity. As such, in an instance in which a work request received by the scheduler 904 may require a large/high amount of processing resources, the scheduler 904 may select a CPU core 910 from the group/set of N CPU cores 910 that has a designated large/high processing capacity.

Similarly, in an instance in which a work request received by the scheduler 904 may require a medium amount of processing resources, the scheduler 904 may select a CPU core 910 from the group/set of N CPU cores 910 that has a designated medium processing capacity. Additionally, in an instance in which a work request received by the scheduler 904 may require a small/low amount of processing resources, the scheduler 904 may select a CPU core 910 from the group/set of N CPU cores 910 that has a designated small/low processing capacity.

At operation 5, in response to the selected CPU core 910 processing the work request associated with the tag and the state in the message associated with operation 4, the selected CPU core 910 may send/transmit a message to the HW datapath 912 indicating that the work request is being processed and may indicate the associated/assigned tag (e.g., the unique identifier). The HW datapath 912 may also be referred to herein as HW datapath module 912 or datapath module 912. In some examples, the HW datapath module 912 may be an example of the HW datapath module 820. For purposes of illustration and not of limitation, for example, in an instance in which the work request is the first work request described in an example above, the selected CPU core 910 may indicate in the message sent/transmit to the HW datapath module 912 the tag and an indication that the sending of the message of 100 kilobytes but sending the message in chunks of 1,000 bytes at time associated with the first work request is (currently) being processed by the selected CPU core 910.

In response to receipt of the message by the HW datapath module 912 from the selected CPU core 910, the HW datapath module 412 may send a ping message (e.g., a ping packet) to the selected CPU core 910 requesting a reply/response to the message indicating whether the work request (e.g., the first work request) is completed. In response to receipt of the ping message, the selected CPU core 910 may reply to the HW datapath module 912 that the work request is complete. In this regard, the HW datapath module 912 may determine that the work request (e.g., first work request) is completed successfully.

In some other examples, in an instance in which the HW datapath module 912 may not receive a reply from the selected CPU core 910, in response to the ping message received by the selected CPU core 910, within a predetermined time period (e.g., expiration of the predetermined time period), the HW datapath module 912 may determine that the work request failed. In another example, the HW datapath module 912 may receive a reply from the selected CPU core 910 but the reply may indicate a link failure and/or the like causing the work request to be unsuccessfully performed by the selected CPU core 910. In this regard, the HW datapath module 912 may determine/designate that the work request (e.g., the first work request) is complete but failed to be performed successfully. As such, the HW datapath module 912 may determine completions for each of the work requests being processed by CPU cores 910 if the completion of the work requests is associated with successful processing of the work requests or failure of the processing (e.g., unsuccessful) of the work requests.

At operation 6, the HW datapath module 912 may send/transmit a message to the scheduler 904 indicating the completion of a corresponding work request (e.g., the first work request) and this message may also include the tag (e.g., the unique id) associated with the work request. For instance, in the example of the first work request, the HW datapath module 912 may generate a message indicating successful completion of processing the first work request by the selected CPU core 910, along with the corresponding tag (e.g., the unique id). In response to receipt of messages indicating completion of the work requests, the scheduler 904 may provide an indication in one or more of the status registers of the core availability status 908 indicating that the prior selected CPU core 910 selected to process the work request (e.g., the first work request) is currently available and free to process other newly received work requests.

At operation 7, the scheduler 904 may generate a completion descriptor that may be sent/transmitted to the corresponding application(s) 900 and/or the one or more requesting entities 902 that originated the work request and that sent the work request to the scheduler 904. The completion descriptor may indicate, and may be an acknowledgement, that the work request(s) is processed.

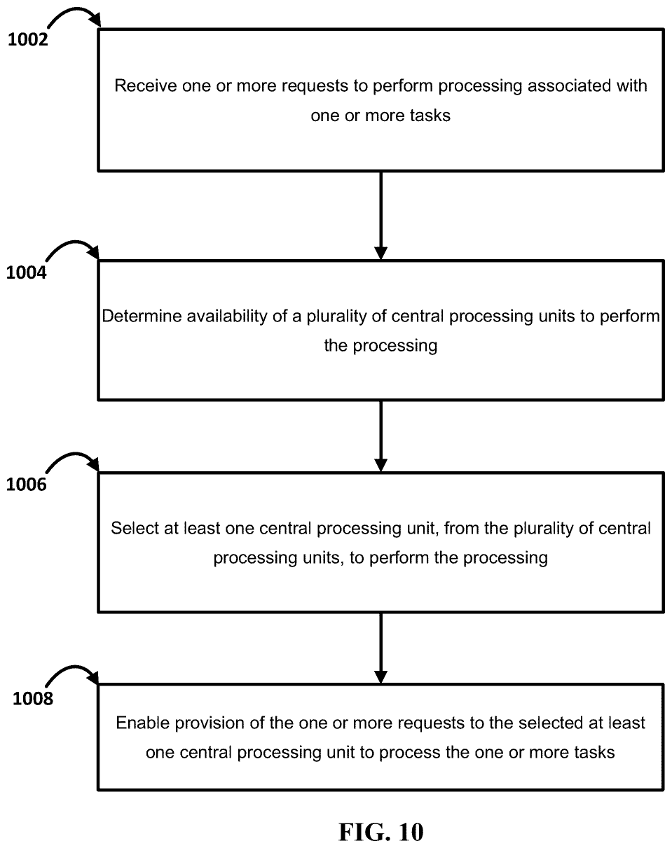

FIG. 10 illustrates an example flowchart illustrating operations for scheduling one or more central processing units to facilitate requests for processing according to examples of the present disclosure. At operation 1002, a device (e.g., scheduler 816, scheduler 904) may receive one or more requests to perform processing associated with one or more tasks. As an example, the one or more requests may be one or more work requests. The work requests may be generated by one or more applications (e.g., application(s) 900) and/or one or more requesting entities (e.g., one or more requesting entities 902). The one or more applications and/or the one or more requesting entities may send the work requests to the device. In some examples, the one or more tasks may be examples of workloads that may need processing by one or more central processing units (e.g., CPU cores 910, core CPUs 817).

At operation 1004, a device (e.g., scheduler 816, scheduler 904) may determine availability of a plurality of central processing units to perform the processing. The central processing units may be CPU cores 910. In some other examples, the central processing units may be core CPUs 817. In some instances, for example, the device (e.g., scheduler 816, scheduler 904) may determine the availability by analyzing one or more indications associated with one or more status registers (e.g., of core availability status 908) indicating which of the plurality of central processing units are available and which of the plurality of central processing units are busy or unavailable. In some other examples, the device (e.g., scheduler 816, scheduler 904) may determine the availability by receiving a message from the plurality of central processing units indicating whether the plurality of central processing units are available to perform the processing or are busy or unavailable to perform the processing.

At operation 1006, a device (e.g., scheduler 816, scheduler 904) may select at least one central processing unit, from the plurality of central processing units, to perform the processing. For example, the device may select a CPU core 910 from a group/set of N CPU cores 910 in which the selected CPU core 910 is determined to be available for processing (e.g., processing tasks of the one or more requests). At operation 1008, a device (e.g., scheduler 816, scheduler 904) may enable provision of the one or more requests to the selected at least one central processing unit to process the one or more tasks. In response to the selecting of the at least one central processing unit, the device may assign a tag (e.g., a unique id) to the one or more requests. Additionally, the device may determine at least one state (e.g., an IP address, etc.) associated with the one or more requests.

The device may determine the state by analyzing data to complete the one or more tasks, from a state table (e.g., HW state table 906, HW state table(s) 805), associated with the one or more requests. The device may enable the provision by sending the one or more requests, the tag (e.g., a unique id) and the determined state to the selected at least one central processing unit to enable the selected at least one central processing unit to initiate the processing. The device may determine that the processing associated with the one or more tasks is complete in response to a determination indicating the processing by the selected at least one central processing unit is successful or failed. The HW datapath module 912 may determine the indicating of the processing by the selected at least one central processing unit is successful or failed in response to sending a ping message (e.g., a ping packet) to the selected at least one central processing unit. In this regard, the HW datapath module 912 may provide an indication to the device (e.g., scheduler 816, scheduler 904) indicating that the one or more work requests are complete.

The device (e.g., scheduler 816, scheduler 904) may further generate an indication that the selected at least one central processing unit is available to perform other processing of at least one new request associated with one or more other tasks in response to receipt of the indication that the processing by the at least one central processing unit is successful or failed. The device may also enable provision of a completion descriptor to an application (e.g., application(s) 900) or an entity (e.g., one or more requesting entities 902) that generated the one or more requests. The completion descriptor may indicate a completion of the processing associated with the one or more requests. In some examples, the tasks may include one or more artificial intelligence transport of content and/or machine learning transport of data across, or associated with, a network (e.g., network 740). In some other examples, the tasks may include any other suitable tasks associated with the network (e.g., network 740).

### C. Low Power System for Acoustic Event Detection

### Technical Field

The examples of the present disclosure generally relate to acoustic event detection and, more particularly, to systems, methods, and non-transitory computer-readable mediums for acoustic event detection on electronic devices.

### Background

Acoustic event detection (AED) algorithms are a type of machine learning algorithm that may analyze audio signals to automatically detect specific types of sounds, such as speech, music, environmental noise, and other acoustic events. These algorithms may use various techniques such as signal processing, pattern recognition, and statistical analysis to analyze audio signals and identify specific patterns that correspond to different types of acoustic events. The input data for these algorithms may be captured from various sources such as microphones, sensors, and other audio recording devices. Acoustic event detection algorithms typically have applications in various fields such as smart devices, surveillance, and automotive safety. For example, these algorithms may be used to detect the sound of glass breaking in a surveillance system, monitor a patient's breathing patterns in a healthcare setting, or detect car horns and sirens for driver assistance in an automotive safety system.

An AED system may help in understanding a user's environment by analyzing the ambient audio characteristics of the environment. The acoustic contextual information may be used to improve the user's experience with a device by enabling different states such as photo capture mode, surrounding awareness mode and notification focus mode, etc. In some instances, the acoustic contextual information used to enable different states may require some existing AED systems to typically operate in an always-on manner, which may cause more device power consumption than desired. As such, it may be beneficial to provide techniques to overcome these drawbacks.

### Brief Summary

Aspects of the subject technology may include a method that includes obtaining a first audio data and a first label indicating an acoustic event, wherein the first audio data comprises the acoustic event. The method may also include generating a teacher model trained based on the first audio data and the first label to identify the acoustic event. The method may also include obtaining a second audio data comprising the acoustic event. The method may also include generating, by the teacher model, a second label of the acoustic event in the second audio data. The method may also include generating a student model trained based on the second audio data and the second label to identify the acoustic event.

Aspects of the subject technology also include an apparatus that includes a processor and a memory. The memory stores computer-readable instructions that, when executed by the processor, cause the processor to obtain a first audio data and a first label indicating an acoustic event, wherein the first audio data comprises the acoustic event. The computer-readable instructions may also cause the processor to generate a teacher model trained based on the first audio data and the first label to identify the acoustic event. The computer-readable instructions may also cause the processor to obtain a second audio data comprising the acoustic event. The computer-readable instructions may also cause the processor to generate, by the teacher model, a second label of the acoustic event in the second audio data. The computer-readable instructions may also cause the processor to generate a student model trained based on the second audio data and the second label to identify the acoustic event.

Aspects of the subject technology further include a non-transitory computer-readable medium storing instructions that, when executed by a processor, cause the processor to obtain a first audio data and a first label indicating an acoustic event, wherein the first audio data comprises the acoustic event. The computer-readable instructions may also cause the processor to generate a teacher model trained based on the first audio data and the first label to identify the acoustic event. The computer-readable instructions may also cause the processor to obtain a second audio data comprising the acoustic event. The computer-readable instructions may also cause the processor to generate, by the teacher model, a second label of the acoustic event in the second audio data. The computer-readable instructions may also cause the processor to generate a student model trained based on the second audio data and the second label to identify the acoustic event.

A system for detecting acoustic events at low latency with low power consumption is disclosed. The system includes obtaining a first audio data and a first label indicating an acoustic event, wherein the first audio data comprises the acoustic event. The method may also include generating a teacher model trained based on the first audio data and the first label to identify the acoustic event. The method may also include obtaining a second audio data comprising the acoustic event. The method may also include generating, by the teacher model, a second label of the acoustic event in the second audio data. The method may also include generating a student model trained based on the second audio data and the second label to identify the acoustic event.

### Description

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional virtual worlds, online games (e.g., video games), one or more content items such as, for example, images, videos, non-fungible tokens (NFTs) and in which the content items may, for example, be purchased with digital currencies (e.g., cryptocurrencies) and/or other suitable currencies. In some examples, a Metaverse or Metaverse network may enable the generation and provision of immersive virtual spaces in which remote users can socialize, collaborate, learn, shop and engage in various other activities within the virtual spaces, including through the use of augmented/virtual/mixed reality.

As referred to herein, “teacher model(s)” may refer to a machine learning model (e.g., neural network) that may be designed without any constraints related to the deployment platform (e.g., a portable electronic device). The teacher model(s) may operate on additional inputs that may not be available for a student model. The teacher model(s) may generate a supervisory label (e.g., pseudo-labels) on which the student model may be trained. This supervision may or may not be combined with ground-truth supervision (e.g., manually labeled data) for training a student model.

As referred to herein, “student model(s)” may refer to a machine learning model (e.g., neural network) that may be used in a deployment platform (e.g., a portable electronic device) where it may work/operate under the computation constraints (e.g., mobile device compute power) and the available input characteristics (e.g., real time audio input). The student model(s) may be trained with a combination of supervision from one or more teacher models (e.g., via pseudo-labels) and also ground-truth data (e.g., manually labeled data).

As referred to herein, “acoustic event(s)” may refer to time duration (e.g., with a start and end timestamp) within an audio signal that includes a sound of a semantically meaningful class. Some examples may include the sound of an animal or an object in action. The set of possible types of acoustic events may be defined in any required manner as desired by a deployment scenario.

As referred to herein, “labeled bag(s)” may refer to a collection of data samples along with their annotations. A bag inherits a label based on the labels of the constituent data samples. For example, a positive label bag may refer to a collection of instances where at least one of the constituent data samples is labeled as positive for some concept. A negative label bag may refer to a collection where all of the constituent data samples are labeled as negative for a concept.

As referred to herein, “pseudo-labels” may refer to labels given to data samples using methods that do not involve human supervision. For example, a pretrained model can be used to generate labels for a set of data samples, which can be used as a training dataset for a different model (e.g., pseudo-labeled training data).

As referred to herein, “ground-truth” may refer to manually generated labels given to data samples. The labels may be obtained directly for the concept of interest or may be derived from other concepts where the manual labels were available.

AED systems or applications have been widely used in various applications such as surveillance, healthcare, and smart homes. However, the use of such algorithms in portable electronic devices (e.g., smart glasses) may be challenging due to several factors. First, portable electronic devices may often have limited processing power, which may make it difficult to run complex in real time. Second, these devices typically have limited memory, which may hinder the storage of large amounts of data required for acoustic event detection systems or applications. Third, running complex and/or always-on AED systems or applications on portable electronic devices may consume an inordinate amount of battery power, which may be a challenge for devices with limited battery life. These challenges may pose significant obstacles in the development and deployment of AED systems and applications in electronic devices (e.g., portable electronic devices). The subject technology introduces novel solutions and optimization strategies to address these challenges and enable the effective use of AED systems/applications on electronic devices.

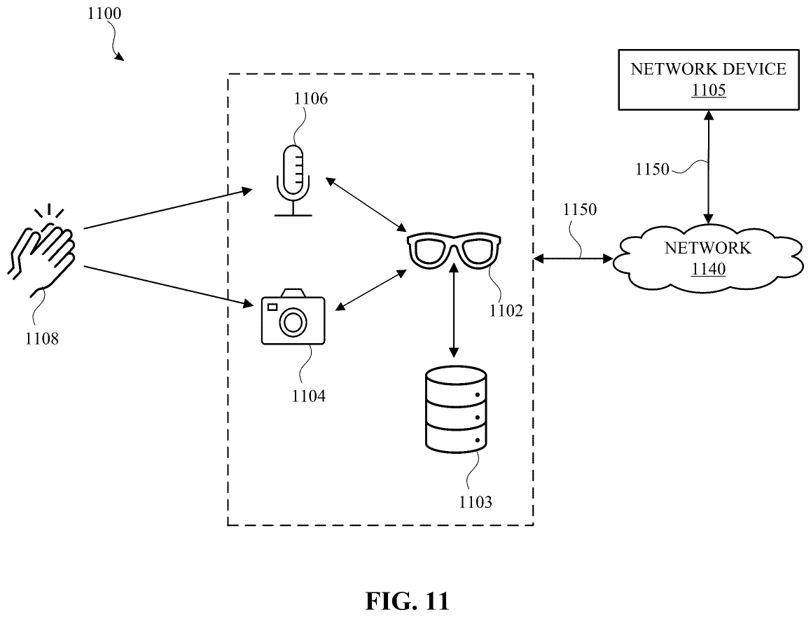

FIG. 11 illustrates an example system 1100 including a head-mounted device (HMD) 1102, that may include, or be associated with, a camera 1104, a microphone 1106 and a memory 1103 in accordance with one or more examples of the present disclosure. In some examples, the system 1100 may operate in a Metaverse environment. Not all of the depicted components may be used in all examples, however, and one or more examples of the present disclosure may include additional or different components than those shown in FIG. 11. Variations in the arrangement and type of the components may be made without departing from the spirit or scope of the claims as set forth herein. Additional components, different components, or fewer components may be provided.

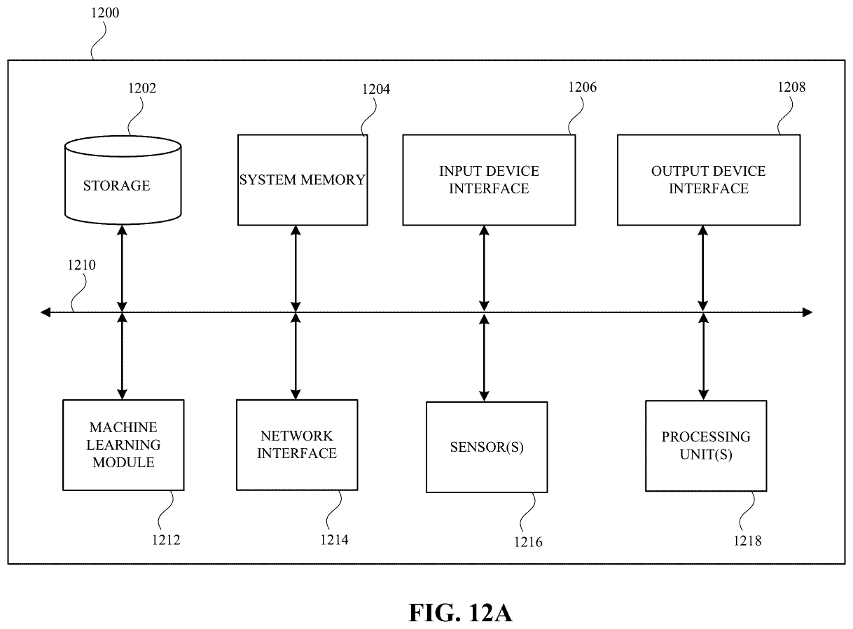

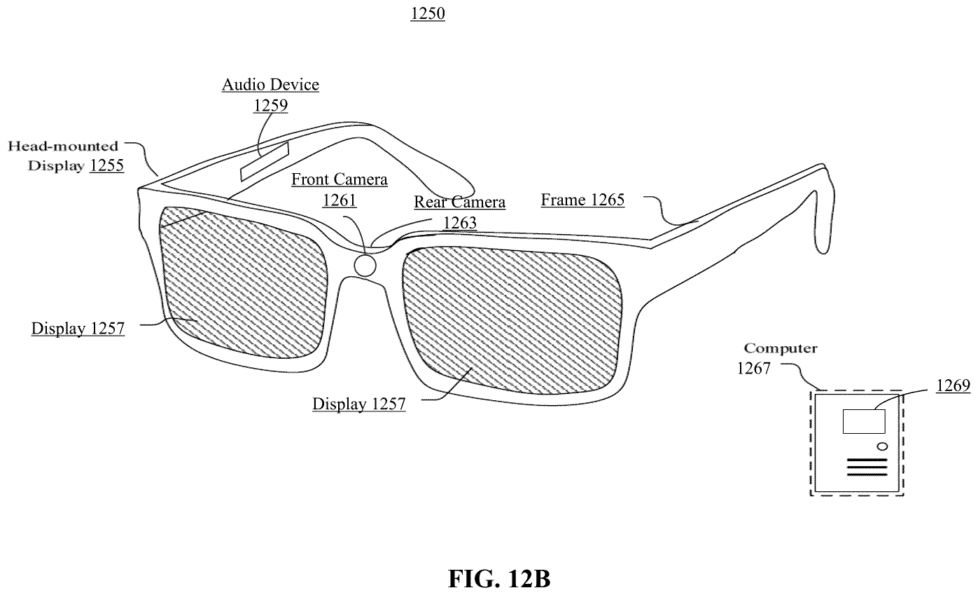

In some examples, the head-mounted device 1102 may be smart glasses (e.g., smart sunglasses, smart augmented reality (AR)/virtual reality (VR) glasses, artificial reality system 1250 of FIG. 12B, etc.) that may enable users to capture photos, images and/or videos. The head-mounted device 1102 may be equipped with a camera 1104 and microphone 1106, which may allow a user (e.g., wearing the head-mounted device 1102) to capture their surroundings in high-resolution videos, photos/images and/or record audio. In this regard, the head-mounted device 1102 may include the camera 1104, the microphone 1106, and the memory 1103. For example, the camera 1104 may capture photos and/or videos of an event 1108, while the microphone 1106 captures audio of the event 1108 and/or voice commands. In some examples, the memory 1103 may store various types of information. For example, the memory 1103 may store photos/images, videos, audio, voice commands, acoustic events, and other content. Additionally, in some examples, the information stored in memory 1103 may be organized according to specific data structures. In particular examples, the memory 1103 may be a relational, columnar, correlation, or other suitable database. Although this disclosure describes or illustrates particular types of databases, this disclosure contemplates any suitable types of databases. Particular examples of the present disclosure may provide interfaces that enable the network device 1105 to manage, retrieve, modify, add, or delete, the information stored in memory 1103.

In some examples, for purposes of illustration and not of limitation, the camera 1104 may, but need not be, a 5-megapixel (MP) dual-camera system. Additionally, in some examples, the event 1108 may be an acoustic event (e.g., a clap event, such as user clapping hands). The head-mounted device 1102 may also include one or more touch controls, allowing the user to cause the head-mounted device to easily start and stop recording, capture photos/videos, and/or play or pause audio (e.g., music). The head-mounted device 1102 may further include a rechargeable battery for powering the head-mounted device 1102. The head-mounted device 1102 may include a processor (e.g., controller 1269 of FIG. 12B) to run/execute/implement an AED application(s) to identify one or more events 1108 (e.g., acoustic events) from audio data captured by an audio sensor, such as a microphone 1106, and may trigger an action(s) in response to an event 1108 (e.g., acoustic event), such as capturing an image with a camera 1104. In some examples, the head-mounted device 1102 may be any suitable electronic device configured to perform AED, such as a security camera, dashcam, and/or the like. The head-mounted device 1102 may communicate with a network device 1105 via at least one link 1150 (e.g., a communication link) across a network (e.g., network 1140). In some examples, the network device 1105 may be a server, a desktop computer, a laptop computer or any other computing device.

As an example and not by way of limitation, one or more portions of network 1140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 1140 may include one or more networks 1140.

Links 1150 may connect the head-mounted device 1102 to network 1140, network device 1105 and/or to each other. This disclosure contemplates any suitable links 1150. In some exemplary embodiments, one or more links 1150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links.

In some examples, an event 1108 (e.g., acoustic event) may be any sound or sequence of sounds that may be detected and distinguished from background noise. Events 1108 may include speech, music, environmental sounds such as birds chirping or waves crashing, and other distinct sounds such as a doorbell ringing or a car engine starting and any other suitable audio related events. Events 1108 may be defined by their acoustic characteristics, such as their frequency, amplitude, and/or duration. For example, a speech acoustic event may be defined by its characteristic frequency spectrum, which may include different frequencies that correspond to different speech sounds, while a music acoustic event may be defined by its rhythmic patterns and/or melody. In some examples, events 1108 may be detected and classified by utilizing machine learning (ML) mechanisms/applications that may analyze audio signals and identify specific patterns that correspond to different types of events.

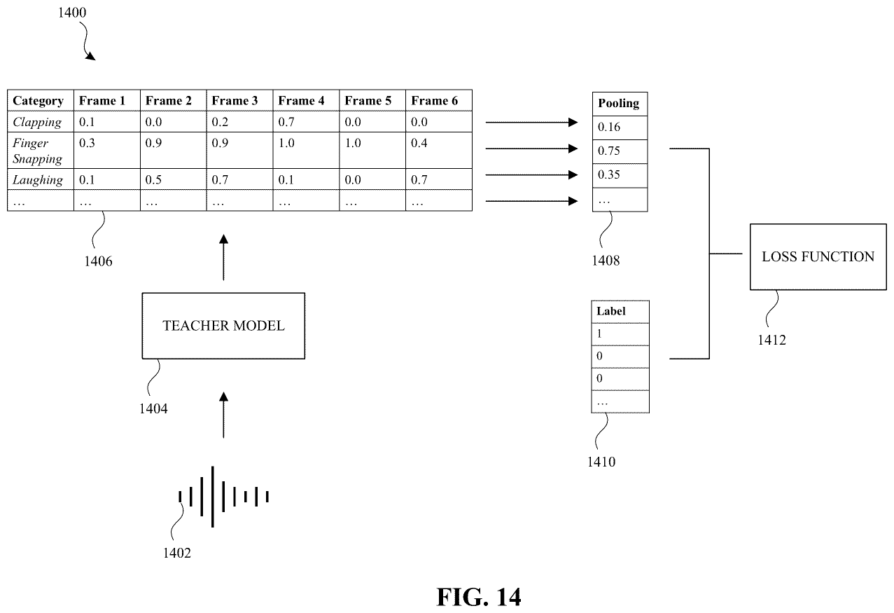

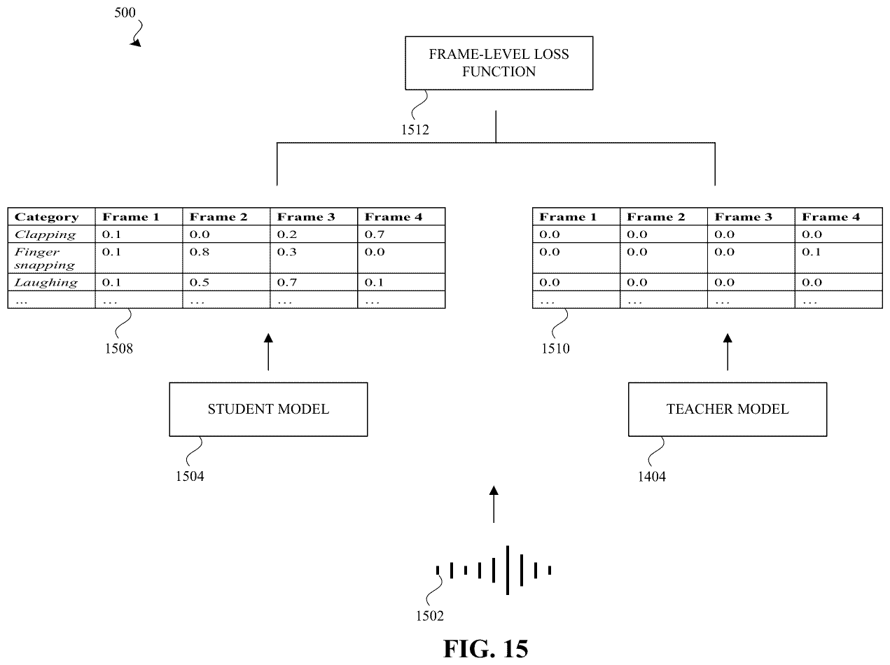

In some examples, network device 1105 may be configured to generate (e.g., train) one or more machine learning models for detecting and classifying events 1108. The machine learning models may include one or more student models (e.g., student model 1504 of FIG. 15) and one or more teacher models (e.g., teacher model 1404 of FIG. 14 and FIG. 15). In some examples, the network device 1105 may provide the one or more machine learning models, generated by the network device 1105, to the head-mounted device 1102. Additionally or alternatively, in some examples the head-mounted device 1102 may generate (e.g., train) one or more machine learning models for detecting and classifying the events 1108. Similarly, these machine learning models, generated by the head-mounted device 1102, may include one or more student models (e.g., student model 1504 of FIG. 15) and one or more teacher models (e.g., teacher model 1404 of FIG. 14 and FIG. 15).

FIG. 12A illustrates an example electronic device 1200 configured to implement the subject technology, in accordance with one or more examples of the present disclosure. In some examples, the electronic device 1200 may be an example of network device 1105. The electronic device 1200 may be a server, desktop, or any other computing device, and may include various types of computer-readable media (e.g., non-transitory computer-readable media) and interfaces for various other types of computer-readable media. The electronic device 1200 includes a bus 1210, a system memory 1204 (and/or buffer), a storage device 1202, an input device interface 1206, an output device interface 1208, a machine learning module 1212, a network interface 1214, sensor(s) 1216, and a processing unit(s) 1218, or subsets and variations thereof. Not all of the depicted components may be used in all examples, however, and one or more examples may include additional or different components than those shown in FIG. 12A. Variations in the arrangement and type of the components may be made without departing from the spirit or scope of the claims as set forth herein. Additional components, different components, or fewer components may be provided.

The bus 1210 collectively represents all system, peripheral, and chipset buses that communicatively connect the numerous internal devices of the electronic device 1200. In one or more examples of the present disclosure, the bus 1210 communicatively connects the processing unit(s) 1218 with the other components of the electronic device 1200. From various memory units, the processing unit(s) 1218 retrieves instructions to execute and data to process in order to execute the operations of the present disclosure. The processing unit(s) 1218 may be a controller(s) and/or a single or multi-core processor or processors in various embodiments.

The storage device 1202 may be a read-and-write memory device. The storage device 1202 may be a non-volatile memory unit that stores instructions and data (e.g., static and dynamic instructions and data), for example, even when the electronic device 1200 is off (e.g., powered off). In one or more embodiments, a mass-storage device (such as a magnetic or optical disk and its corresponding disk drive) may be used as the storage device 1202. In one or more embodiments, a removable storage device (such as a floppy disk, flash drive, and its corresponding disk drive) may be used as the storage device 1202.

Like the storage device 1202, the system memory 1204 may be a read-and-write memory device. However, unlike the storage device 1202, the system memory 1204 may be a volatile read-and-write memory, such as random access memory. The system memory 1204 may store any of the instructions and data that one or more processing units 1218 may need at runtime to perform operations. In one or more embodiments, the processes of the present disclosure are stored in the system memory 1204 and/or the storage device 1202. From these various memory units, the one or more processing unit(s) 1218 retrieves instructions to execute and data to process in order to execute the processes of one or more embodiments, discussed below.

The bus 1210 also connects to the input device interface 1206 and output device interface 1208. The input device interface 1206 enables the electronic device 1200 to receive inputs. For example, the input device interface 1206 allows a user to communicate information and select commands on the electronic device 1200. The input device interface 1206 may be used with input devices such as keyboards, mice, dials, switches, sliders, and other interfaces (physical or virtual) for a user to supply information to the electronic device 1200. The output device interface 1208 may enable, for example, the display of images generated by electronic device 1200. Output devices that may be used with the output device interface 1208 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more embodiments may include devices that function as both input and output devices, such as a touchscreen. In these embodiments, feedback provided to the user can be any form of sensory feedback, such as visual feedback, auditory feedback, or tactile feedback; and input from the user can be received in any form, including acoustic, speech, or tactile input.

The electronic device 1200 may also include a machine learning module 1212. The machine learning module 1212 may be a hardware and/or software module that includes machine learning logic and/or a machine learning application(s). In some examples, machine learning logic may be embodied in the form of computer-readable instructions and may include representation learning, feature learning, convolutional neural networks, artificial neural networks, graph neural networks, attention models, image recognition models, and/or the like, to interpolate or extrapolate outputs in response to a set of inputs based on a set of training data. For example, a machine learning module 1212 may be configured to perform multiple instance learning (MIL). MIL may utilize one or more teacher models and student models. The teacher model(s) may be trained on labeled “bags” where each bag may be one or more positive samples (e.g., samples that may include a known acoustic event) and/or one or more negative samples (e.g., samples that may not include a known acoustic event). In some examples, the teacher model(s) may be an example of the teacher model 1404 of FIG. 14 and/or FIG. 15. The trained teacher model(s) may generate an intermediate output that predicts the presence or absence of an acoustic event in a bag. The student model(s) may then be trained on this intermediate output and may be utilized to predict the labels of new bags. In some examples, the student model(s) may be an example of the student model 1504 of FIG. 15.

The teacher model(s) in MIL may take different forms, such as a convolutional neural network (CNN), support vector machine (SVM), and/or a decision tree. The student model(s) may also take different forms, such as a neural network or a logistic regression model. In some examples, the student model(s) may be a smaller model than the teacher model(s). For example, the teacher model(s) may include more parameters, more training, and/or the like than the student model(s). Accordingly, the student model(s) may enable real time AED with reduced computational requirements and/or power requirements, in relation to the teacher model(s), since student model(s) may be a smaller model than the teacher model(s).

In some alternative examples of the present disclosure, the teacher model(s) and/or the student model(s) may be trained and deployed on a head-mounted device such as, for example, head-mounted device 1102 (e.g., artificial reality system 1250), as described more fully below.

The bus 1210 also couples the electronic device 1200 to one or more networks and/or to one or more network nodes through the network interface 1214. The network interface 1214 may include one or more interfaces that allow the electronic device 1200 to be a part of a network of computers (e.g., a local area network (LAN), a WAN, or a network of networks (the “Internet”)). Any or all components of the electronic device 1200 may be used in conjunction with the present disclosure.

The electronic device 1200 also includes one or more sensors 1216. The sensors 1216 may be used for gathering information about the environment of the user, such as audio and visual data. In some examples, the sensors 1216 may include the microphone 1106, such as an elect, dynamic, or condenser microphone. The sensors 1216 may also include the camera 1104, such as digital cameras or depth cameras.

Embodiments within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory (e.g., the system memory 1204), such as RAM, DRAM, SRAM, T-RAM, Z-RAM, and TTRAM. The computer-readable medium also can include any non-volatile semiconductor memory (e.g., the storage device 1202), such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more embodiments, the tangible computer-readable storage medium can be directly coupled to a computing device, while in other embodiments, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more embodiments are performed by one or more integrated circuits, such as ASICs or FPGAs. In one or more embodiments, such integrated circuits execute instructions that are stored on the circuit itself.

FIG. 12B illustrates an example artificial reality system 1250. The artificial reality system 1250 may include a head-mounted display (HMD) 1255 (e.g., smart glasses) comprising a frame 1265, one or more displays 1257, and a computing device 1267 (also referred to herein as computing device 1267). In some examples, the artificial reality system 1250 may be an example of the head-mounted device 1102. The displays 1257 may be transparent or translucent allowing a user wearing the HMD 1255 to look through the displays 1257 to see the real world (e.g., real world environment) and displaying visual artificial reality content to the user at the same time. The HMD 1255 may include an audio device 1259 (e.g., speakers/microphones) that may provide audio artificial reality content to users. The HMD 1255 may include one or more cameras 1261, 1263 which may capture images and/or videos of environments. In one exemplary embodiment, the HMD 1255 may include a camera(s) 1263 which may be a rear-facing (e.g., rear) camera tracking movement and/or gaze of a user's eyes.

One of the cameras 1261 may be a forward-facing (e.g., front) camera capturing images and/or videos of the environment that a user wearing the HMD 1255 may view. The HMD 1255 may include an eye tracking system to track the vergence movement of the user wearing the HMD 1255. In one exemplary embodiment, the camera(s) 1263 may be the eye tracking system. The HMD 1255 may include a microphone of the audio device 1259 to capture voice input from the user. The artificial reality system 1250 may further include a controller 1269 comprising a trackpad and one or more buttons. The controller 1269 may receive inputs from users and relay the inputs to the computing device 1267. The controller 1269 may also provide haptic feedback to one or more users. The computing device 1267 may be connected to the HMD 1255 and the controller 1269 through cables or wireless connections. The computing device 1267 may control the HMD 1255 and the controller 1269 to provide the augmented reality content to and receive inputs from one or more users. In some example embodiments, the controller 1269 may be a standalone controller or integrated within the HMD 1255. The computing device 1267 may be a standalone host computer device, an on-board computer device integrated with the HMD 1255, a mobile device, or any other hardware platform capable of providing artificial reality content to and receiving inputs from users. In some exemplary embodiments, HMD 1255 may include an artificial reality system/virtual reality system.

In some examples, the artificial reality system 1250 (e.g., by computing device 1267 and/or controller 1269) may generate (e.g., train) one or more machine learning models for detecting and classifying events (e.g., events 1108, acoustic events). The machine learning models, generated by the artificial reality system 1250, may include one or more student models (e.g., student model 1504 of FIG. 15) and one or more teacher models (e.g., teacher model 1404 of FIG. 14 and FIG. 15).

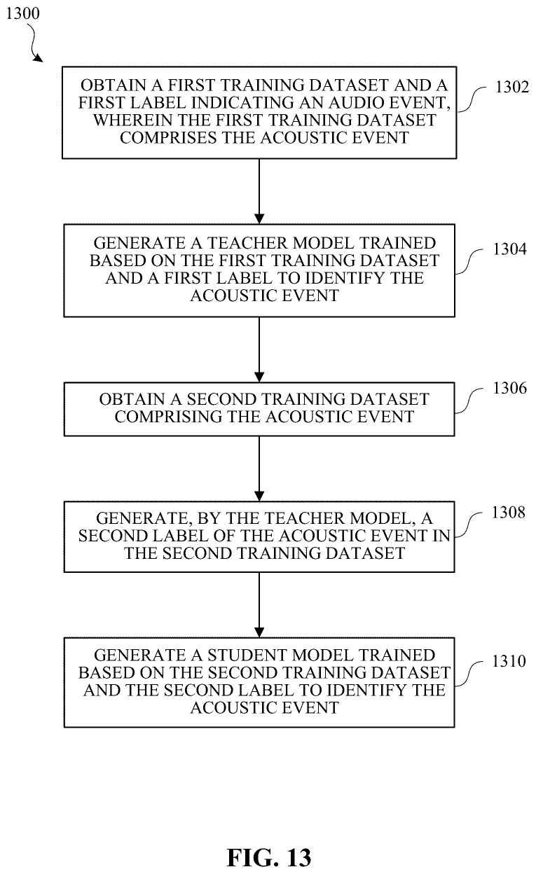

FIG. 13 illustrates a flow diagram of an exemplary process 1300 for training a machine learning model, in accordance with one or more examples of the present disclosure. For explanatory purposes, the process 1300 may primarily be described herein with reference to the electronic device 1200 of FIG. 12A. However, the process 1300 is not limited to the electronic device 1200 and in some examples the process 1300 may be implemented by the head-mounted device 1102 (e.g., the artificial reality system 1250), and one or more blocks (or operations) of the process 1300 may be performed by one or more other components of other suitable devices. Further, for explanatory purposes, the blocks of the process 1300 are described herein as occurring in serial, or linearly. However, multiple blocks of the process 1300 may occur in parallel. In addition, the blocks of the process 1300 need not be performed in the order shown and/or one or more blocks of the process 1300 need not be performed and/or may be replaced by other operations.

In the process 1300, at block 1302, the electronic device 1200 may obtain a first training dataset for training a teacher model. The first training dataset may be accessed (e.g., from the system memory 1204), downloaded, retrieved, generated or otherwise acquired by the electronic device 1200. The first training dataset may include one or more audio data samples that may be labeled as including an acoustic event. For purposes of illustration and not of limitation, for example, audio data may be a recording of a birthday party and may be labeled as including clapping and/or laughing. As another example for purposes of illustration and not of limitation, for example, audio data may be a recording of a sporting event (e.g., a baseball game) and may be labeled as including clapping and/or cheering or any other suitable acoustic event(s).

The audio data of the acoustic event instances may be captured/recorded acoustic events associated with the first training dataset for training the teacher model. The audio data may be a “bag” (e.g., a group) of one or more frames, where a frame may be a fixed period of time (e.g., ten milliseconds (ms)). The audio data may be labeled as including or not including an acoustic event (e.g., clapping) in at least part of the audio data.

At block 1304, the electronic device 1200 may generate a teacher model (e.g., from the machine learning module 1212). The teacher model (e.g., teacher model 1404) may be a machine learning model, such as a decision tree, SVM, or neural network, which may be trained on the first training dataset using a supervised learning algorithm or supervised learning application.

The teacher model may be trained on the first training dataset and a first label(s) (e.g., labeled training dataset) where the presence or absence of an acoustic event(s) may be known/determined for each audio data of the first training dataset. For example, an audio data associated with first training dataset may be labeled (e.g., manually or automatically) as including clapping in at least a portion of the audio data. A goal of training the teacher model may be to learn a function that maps audio data to the presence or absence of an acoustic event in the audio data. In some instances, the teacher model may use additional context (e.g., metadata) from the inputs that may not be available to a student model.

Once the teacher model is trained (e.g., by a supervised machine learning algorithm), the teacher model may be used to predict (e.g., as represented by a probability) the presence or absence of an acoustic event in unlabeled audio data (e.g., audio data where it is not known whether it includes an acoustic event). In some examples, the training of the teacher model may be implemented by the machine learning module 1212. The output of the teacher model (e.g., on unlabeled audio data) may be used to guide the training of the student model, which is designed to detect an acoustic event in individual instances within audio data, where an instance may be the one or more frames of the audio data that actually include the acoustic event.

At block 1306, the electronic device 1200 may obtain a second training dataset including the acoustic event to train a student model (e.g., student model 1504). The second training dataset may be accessed (e.g., from the system memory 1204), downloaded, retrieved, generated or otherwise acquired by the electronic device 1200. Like the first training dataset, the second training dataset may include one or more audio data samples. The one or more audio data samples of the second training dataset may be different from the audio data samples of the first training dataset. In some examples, the second training dataset may be smaller than the first training dataset.

At block 1308, the electronic device 1200 may generate, by the teacher model a second label of, or associated with, an acoustic event in the second training dataset (e.g., associated with one or more audio data samples). In this regard, the teacher model may label the one or more audio data samples of the second training dataset at the frame level (e.g., in 10 ms portions/intervals), whereas the first training dataset was labeled for each audio data as a whole. For purposes of illustration and not of limitation, for example, rather than outputting a likelihood that an audio data sample includes an instance of people laughing, the teacher model may output a probability (e.g., a probability value/score) that each of the frames of the audio data sample is or is part of an instance of people laughing. In some examples, the teacher model may also or instead output a boolean value (e.g., true/false) indicating whether an audio data sample includes an acoustic event. For example, the boolean value may be determined based on whether the probability is above or below a threshold value (e.g., 70%). In some examples, the teacher model may directly use the predicted probability score as supervision. This may be achieved through a loss function designed to accept the probability score as the ground-truth.

At block 1310, the electronic device 1200 may generate a student model (e.g., from the machine learning module 1212) trained based on the second training dataset and the second label to identify the acoustic event (e.g., birthday party, baseball game, etc.). The student model (e.g., student model 1504) may be a machine learning application, such as a decision tree, SVM, or neural network, which may be trained on the second training dataset using a supervised learning algorithm or supervised learning application. As described above, in some examples, the head-mounted device 1102 (e.g., artificial reality system 1250) may be capable of performing each of the blocks 1302, 1304, 1306, 1308, and 1310 of process 1300.

The student model may be trained on the second training dataset in which the presence of an acoustic event may be estimated by the teacher model on one or more frames of the audio data samples of the second training dataset, as described with respect to block 1308. For example, each of the frames of the associated audio data may be automatically labeled by the teacher model that the frame is, or is part of, an instance of clapping. Unlike the goal of training the teacher model, a goal of training the student model may be to learn a function that maps the audio data of the second training dataset to an instance of an acoustic event in the audio data (e.g., clapping may be detected at frames 2-6 of a 20-frame audio clip).

Once the student model is trained, the student model may be deployed on another device, such as for example, the head-mounted device 1102. The student model may be used to predict (e.g., as represented by a probability) or determine an instance (e.g., at the frame level) of an acoustic event in unlabeled audio data (e.g., real time audio data, such as a live birthday party occurring in real time). For example, the student model may receive audio data (e.g., from the microphone 1106 of the head-mounted device 1102 and based on capture of audio of a real time event) and may analyze each of the frames of the audio data as the frames are captured/detected, and may determine a probability (e.g., a probability value/score) of whether a corresponding frame(s) is, or is part of, an instance of a particular acoustic event (e.g., clapping, laughing, cheering, etc.).

The output of the student model (e.g., implemented on unlabeled audio data) may be used to trigger an action(s) (e.g., by the head-mounted device 1102, artificial reality system 1250). For instance, in some examples, detection of acoustic event(s) (e.g., clapping, finger snapping, laughing, etc.) in captured/recorded audio data (e.g., audio content captured in real time associated with an event such as a live event) may cause/trigger a camera (e.g., camera 1104, camera 1261, camera 1263) of the head-mounted device to capture an image(s)/video(s) associated with the moment in time associated with the detected acoustic event. In some examples, a microphone (e.g., microphone 1106, audio device 1259) of the head-mounted device 1102 may capture/record the audio data.

The subject technology may detect acoustic events with reduced latency as compared to other conventional/existing AED approaches at least in part because the student model is trained at the frame level and with potentially greater amounts of training data (e.g., pseudo-labeled training data automatically generated by the teacher model). The subject technology may also detect acoustic events with reduced power consumption as compared to other conventional/existing AED approaches at least in part because the student model is a smaller model (e.g., has fewer parameters than the teacher model). Consequently, the student model may be used to improve the user's experience with a device by enabling different states of the device such as photo capture mode, surrounding awareness mode and notification focus mode, etc., that may be responsive to particular acoustic events.

In some examples of the present disclosure, the teacher model may not be utilized in a deployment scenario (e.g., a device being utilized in a real-world environment such as for example head-mounted device 1102). In this regard, it may be the case, for example, that only the student model is deployed on such a device (e.g., head-mounted device 1102) and acoustic event detections from the student model may be utilized to perform various actions (e.g., photo capture based on detected audio, etc.).

FIG. 14 illustrates an example training process 1400 for a teacher model 1404. The teacher model 1404 may be a type of model that may be trained on labeled audio data of a training dataset. The labeled audio data may include audio data 1402, which may include one or more instances of one or more acoustic events. An acoustic event may be any event of interest such as clapping, finger snapping, and/or laughing, as shown in table 1406. It should be understood that the acoustic events that may be covered by the subject technology are not limited to those shown in table 1406.

In this example, the audio data 1402 may be a capture/recording of audio in real time (e.g., by microphone 1106). An example of the capture/recording of audio in real time may be, for purposes of illustration and not of limitation, audio associated with a party, sporting event, concert or any other suitable real time audio capture of an event. The audio data 1402 may be a predetermined length (e.g., 3 seconds) and may include a plurality of frames (e.g., at least 6 frames, each 10 milliseconds long). As shown in FIG. 14, the audio data 402 includes, or is associated with, a label indicating that the audio data 1402 includes at least one instance of one or more acoustic events in at least a portion/section of the audio data 1402. For example, table 1410 shows that the audio data 1402 is labeled as including at least one instance of clapping, as indicated by a ‘1’ in the clapping row and ‘0’ in the finger snapping and laughing rows.

As shown in table 1406, the teacher model 1404 may determine a probability score for the audio data 1402 that indicates the likelihood that the audio data 1402 includes a predetermined acoustic event by determining probability scores for one or more frames associated with the audio data 1402 and then pooling (e.g., combining) the probability scores across the frames. In this example, the teacher model 1404 may determine the probability scores, as shown in table 1406, for a plurality of frames of the audio data 1402 based in part on analyzing and comparing the frames of the audio data 1402 in relation to the first training dataset, described above, associated with the teacher model 1404.

For example, the teacher model 1404 may determine the probability scores for a plurality of frames of the audio data 1402 as shown in table 1406. Although only six frames are shown in table 1406, it should be understood that the audio data 1402 may contain more or less than six frames. In this example, regarding frame 1, the teacher model 1404 may determine a 10% (e.g., 0.1) probability that the frame 1 includes clapping and laughing and a 30% (e.g., 0.3) probability that the frame 1 includes finger snapping. With respect to frame 2, the teacher model 1404 may determine a 0% (e.g., 0.0) probability that the frame 2 includes clapping, and may determine 90% (e.g., 0.9) probability that the frame includes finger snapping. Additionally, the teacher model may determine a 50% (e.g., 0.5) probability that the frame 2 includes laughing. Pertaining to frame 3, the teacher model 1404 may determine a 20% (e.g., 0.2) probability that the frame includes clapping, may determine a 90% (e.g., 0.9) probability that the frame 3 includes finger snapping, and may determine a 70% (e.g., 0.7) probability that the frame includes laughing. Regarding frame 4, the teacher model 1404 may determine a 70% (e.g., 0.7) probability that the frame 4 includes clapping, may determine 100% (e.g., 1.0) probability that the frame 4 includes finger snapping, and may determine a 10% (e.g., 0.1) probability that the frame includes laughing. With regards to frame 5, the teacher model 1404 may determine a 0% (e.g., 0.0) probability that the frame includes clapping or laughing and a 100% (e.g., 1.0) probability that the frame includes finger snapping. Pertaining to frame 6, the teacher model 1404 may determine a 0% (e.g., 0.0) probability that the frame includes clapping, may determine 40% (e.g., 0.4) probability that the frame includes finger snapping, and may determine a 70% (e.g., 0.7) probability that the frame includes laughing. In the example of FIG. 14, the ranges of probability scores may be from 0% to 100% (e.g., spanning corresponding probability values in a range of 0.0 to 1.0).

As the teacher model 1404 is trained based on the audio data as a whole (rather than the instances within the audio data), the probabilities determined for each of the frames of audio data 1402 may be pooled together to determine a prediction for each of the categories associated with the entire audio data 1402. Pooling may include average pooling, where the average probability score across all instances in an audio data may be determined. In some examples, other pooling strategies may be utilized. One other pooling strategy may be maximum pooling, in which the maximum probability score across all instances in the bag may be used as the prediction for the audio data. Another pooling strategy may be attention-based pooling, in which pooling weights may be learned based on training data (e.g., the first training dataset). Generally, a pooling function may take a variable length input and convert it to an output of single unit.

As shown in table 1408, the pooled probabilities may be calculated based on average pooling. The pooled probabilities may include a 16% (0.16) probability that the audio data 1402 includes at least one instance of clapping, a 75% (0.75) probability that the audio data 1402 includes at least one instance of finger snapping, and a 35% (0.35) probability that the audio data 1402 includes at least one instance of laughing. The teacher model 1404 may determine these pooled probabilities indicated in table 1408.

The training process 1400 may also include a loss function 1412, such as binary cross entropy loss, which may measure how well the teacher model 1404 is performing in terms of the teacher model's 1404 ability to predict the correct output (e.g., acoustic event) given a set of input data (e.g., the audio data 1402). A goal of training a machine learning model may be to minimize the loss function, which means determining the set of model parameters that may generate the lowest possible value of the loss function. Accordingly, the loss function 1412 may take as input the pooled probability scores for the audio data 1402 determined by the teacher model 1404 (as shown in table 1408) and the labels of the audio data 1402 (as shown in table 1410) and may determine a measure of the discrepancy between the pooled probability score and true labels.

One or more parameters (e.g., weights in convolutional layers) of the teacher model 1404 may then be adjusted in a manner that reduces the value of the loss function 1412, using techniques such as, for example, gradient descent. The one or more parameters of the teacher model 1404 being adjusted to reduce the value of the loss function 1412 may be performed on each of the items of audio data in the training dataset (e.g., the first training dataset). The loss function 1412 may be cross entropy loss, which takes two vectors as inputs: a prediction vector (e.g., table 1406, e.g., the pooled probabilities) and a label vector (e.g., table 1408). The training process 1400 may also use a gradient descent algorithm/application to tune the parameters of the teacher model 1404 such that the difference between the prediction vector and the label vector is reduced.

FIG. 15 illustrates an example training process 1500 for a student model 1504. In some examples, the student model 1504 may be a simpler and/or smaller machine learning model than the teacher model 1404. For example, the student model 1504 may have fewer parameters (e.g., layers, nodes per layer, connections between nodes, etc.) than the teacher model 1404. The reduced size and complexity of the student model may enable the student model 1504 to determine instances of acoustic events with lower power consumption and latency as compared to other conventional/existing AED approaches. The lower power consumption and/or latency may also enable the student model 1504 to be a viable machine learning model to operate/function on electronic devices (e.g., portable electronic devices), such as for example smart glasses (e.g., head-mounted device 1102).

Unlike the teacher model 1404, the student model may be trained at the frame level (e.g., the teacher model may provide labels/scores at the frame level). The student model 1504 may be trained to determine predictions regarding the label(s) of individual instances (e.g., frames of an audio data 1502), rather than bags of instances (e.g., the audio data 1502). By training the student model to mimic the frame level scores of the teacher model, it makes the student model able to detect an event as soon as it appears in the input frames, thereby leading to reduced latency in triggering for an event.

To train the student model 1504, the audio data 1502 may be provided to the student model 1504 and the teacher model 1404. In some examples, the audio data 1502 may be associated with a real time event (e.g., a party, sporting event, concert, etc.). The audio data 1502 may be similar in form to the audio data 1402 except that it may not have been labeled as including an acoustic event.

The student model 1504 may determine a probability score for one or more frames of the audio data 1502 that indicates the likelihood that a frame includes an acoustic event(s). For example, the student model 1504 may determine the probability scores for a plurality of frames of the audio data 1502 as shown in table 1508. With regards to frame 1, the student model 1504 may determine a 10% (e.g., 0.1) probability that the frame 1 includes clapping, finger snapping, and laughing. Regarding frame 2, the student model 504 may determine a 0% (e.g., 0.0) probability that the frame 2 includes clapping, may determine an 80% (e.g., 0.8) probability that the frame 2 includes finger snapping, and may determine a 50% (e.g., 0.5) probability that the frame 2 includes laughing. Pertaining to frame 3, the student model 504 may determine a 20% (e.g., 0.2) probability that the frame 3 includes clapping, may determine a 30% (e.g., 0.3) probability that the frame 3 includes finger snapping, and may determine a 70% (e.g., 0.7) probability that the frame 3 includes laughing. At frame 4, the student model 1504 may determine a 70% (e.g., 0.7) probability that the frame 4 includes clapping, may determine a 0% (e.g., 0.0) probability that the frame 4 includes finger snapping, and may determine a 10% (e.g., 0.1) probability that the frame 4 includes laughing.

Additionally, the teacher model 1404 may also determine a pseudo-label (e.g., a probability score that is treated as a label for purposes of training the student model 1504) for one or more frames of the audio data 1502 representing the probability that a particular category of acoustic event is present in the frame(s). For example, the teacher model 1404 may also determine one or more probability scores for a plurality of frames of the audio data 1502 as shown in table 1510. With regards to frames 1, 2, and 3, the teacher model 1404 may determine a 0% (e.g., 0.0) probability that the frames 1, 2 and 3 include clapping, finger snapping, and laughing. Regarding frame 4, the teacher model 1404 may determine a 0% (e.g., 0.0) probability that the frame 4 includes clapping, may determine a 10% (e.g., 0.1) probability that the frame 4 includes finger snapping, and may determine a 0% (e.g., 0.0) probability that the frame 4 includes laughing.

The training process 1500 may also include a loss function 1512, such as binary cross entropy loss, which may measure how well the student model 1504 is performing in terms of the ability to predict the correct output (e.g., acoustic event) given a set of input data (e.g., the audio data 1502). A goal of training a machine learning model may be to minimize the loss function, which means determining the set of model parameters that generates the lowest possible value of the loss function. Accordingly, the loss function 1512 may take as an input the probability scores of table 1508 generated by the student model 1504 and the corresponding pseudo-labels as shown in table 1510 generated by the teacher model 1404 and may determine a measure of the discrepancy between the probability scores and pseudo-label for each frame.

One or more parameters (e.g., weights in convolutional layers) of the student model 1504 may then be adjusted in a manner that reduces the value of the loss function 1512, using techniques such as, for example, gradient descent. The one or more parameters of the student model 1504 being adjusted to reduce the value of the loss function 1512 may be performed for each of the frames of audio data in the training dataset (e.g., the second training dataset). For example, the loss function 1512 may be cross entropy loss.

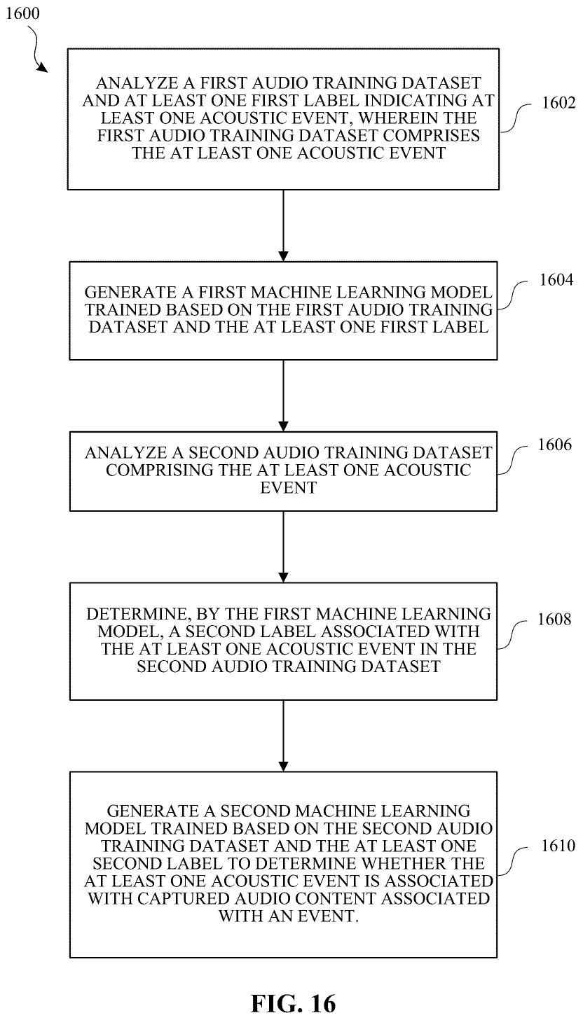

FIG. 16 illustrates an example flowchart illustrating operations for detecting acoustic events for electronic devices according to some examples of the present disclosure. At operation 1602, a device (e.g., electronic device 1200, head-mounted device 1102) may analyze a first audio training dataset and at least one first label indicating at least one acoustic event. The first audio training dataset may include the at least one acoustic event. The first audio training dataset may also be referred to herein as the first training dataset described above. In some examples, the at least one acoustic event may be one or more of clapping, finger snapping, laughing or any other suitable acoustic event.

At operation 1604, a device (e.g., electronic device 1200, head-mounted device 1102) may generate a first machine learning model (e.g., teacher model 1404) trained based on the first audio training dataset and the at least one first label. At operation 1606, a device (e.g., electronic device 1200, head-mounted device 1102) may analyze a second audio training dataset comprising the at least one acoustic event. The second audio training dataset may also be referred to herein as the second training dataset described above.

At operation 1608, a device (e.g., electronic device 1200, head-mounted device 1102) may determine, by the first machine learning model, a second label associated with the at least one acoustic event in the second audio training dataset.

At operation 1610, a device (e.g., electronic device 1200, head-mounted device 1102) may generate a second machine learning model (e.g., student model 1504) trained based on the second audio training dataset and the at least one second label to determine whether the at least one acoustic event is associated with captured audio content associated with an event. In some examples, the captured audio content associated with the event may be captured/recorded audio data items associated with a real time event.

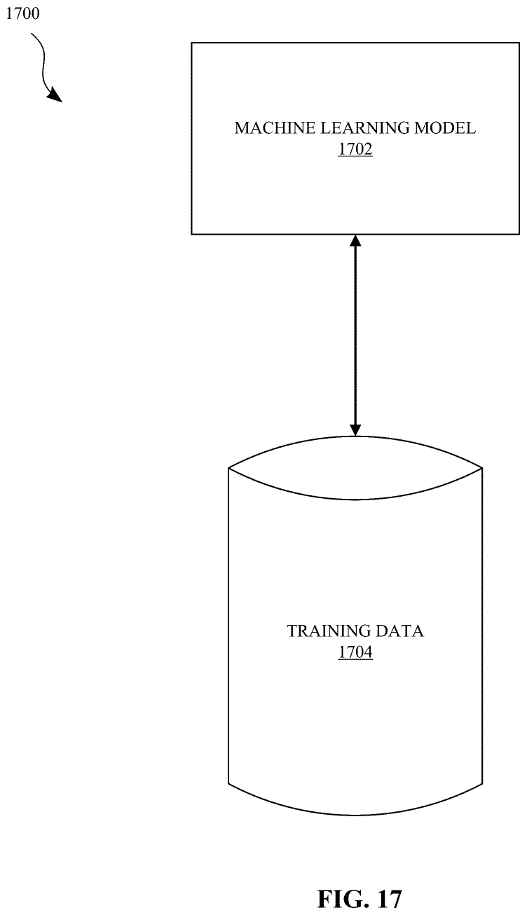

FIG. 17 illustrates an example machine learning framework 1700 including machine learning model 1702 and training database 1704, in accordance with one or more examples of the present disclosure. The framework 1700 may be hosted remotely. Alternatively, the framework 1700 may reside within the head-mounted device 1102 shown in FIG. 11 and/or be processed by the machine learning module 1212 shown in FIG. 12A. The machine learning model 1702 is operably coupled to the training database 1704. The machine learning model 1702 may comprise one or more types of machine learning models, such as a teacher model 1404 and/or a student model 1504.

The training database 1704 may include a plurality of training datasets, which may include one or more audio data samples. The audio data may include labeled and/or unlabeled data. Audio data may be labeled as including one or more instances of an acoustic event. For example, an audio data may be a ten second clip of a birthday party and an acoustic event in the audio data may be clapping. Audio data may be unlabeled when it does not include an indication that the audio data includes one or more instances of an acoustic event. The labeled training datasets may be used, for example, to train one or more machine learning models, such as the teacher model 1404. The unlabeled training datasets may be used, for example, to validate the training of one or more trained machine learning models. In some embodiments, the unlabeled training datasets may be used, for example, to generate pseudo-labeled training datasets, which are training datasets that are labeled based on an estimation by a machine learning model (e.g., the teacher model 1404) that the training datasets include one or more acoustic events. The pseudo-labeled training datasets may be used to train other machine learning models (e.g., the student model 1504).

The training database 1704 employed by the machine learning model 1702 may be fixed or updated periodically. Alternatively, the training database 1704 may be updated in real time based upon the evaluations performed by the machine learning model 1702 in a non-training mode. This is illustrated by the double-sided arrow connecting the machine learning model 1702 and training database 1704.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
determining a designated network path configured to transfer traffic data from a first communication device, via one or more network switches, to a second communication device;
determining at least one network failure, associated with the network path, causing at least a subset of the traffic data to be blocked along the network path;
determining one or more tracker windows associated with one or more other network paths that are available to transfer traffic content; and
selecting at least one network path of the one or more other network paths to transfer the at least the subset of the traffic data to the second communication device.

2. The method of claim 1, wherein:
the first communication device comprises a first transmitter device and the second communication device comprises a first receiver device.

3. The method of claim 1, wherein:
the traffic data comprises one or more packets.

4. The method of claim 1, wherein:
the at least one network failure comprises at least one of a link failure, a network switch failure or a network switch misconfiguration.

5. The method of claim 1, further comprising:
the determining the one or more tracker windows comprises determining that the one or more other network paths are transferring other traffic content across a network associated with the network path.

6. The method of claim 1, further comprising:
assigning one or more priorities or weightings, to the one or more other network paths, comprising designating one or more percentages, to the one or more other network paths, indicating at least one percentage associated with the one or more other network paths allocated to transfer network traffic content across a network.

7. The method of claim 6, further comprising:
reassigning the priorities or weightings in response to determining at least one failure associated with the at least one network path of the one or more other network paths.

8. The method of claim 1, further comprising:
migrating the at least the subset of the traffic data to the at least one network path of the one or more other network paths to transfer the at least the subset of the traffic data to the second communication device.

9. The method of claim 1, further comprising:
reclaiming one or more resources associated with the at least one network failure, associated with the network path; and
reallocating the one or more resources to the one or more other network paths or one or more newly generated network paths.

10. An apparatus comprising:
one or more processors; and
at least one memory storing instructions, that when executed by the one or more processors, cause the apparatus to:
determine a designated network path configured to transfer traffic data from the apparatus, via one or more network switches, to a second communication device;
determine at least one network failure, associated with the network path, causing at least a subset of the traffic data to be blocked along the network path;
determine one or more tracker windows associated with one or more other network paths that are available to transfer traffic content; and
select at least one network path of the one or more other network paths to transfer the at least the subset of the traffic data to the second communication device.

11. The apparatus of claim 10, wherein:
the apparatus comprises a first transmitter device and the second communication device comprises a first receiver device.

12. The apparatus of claim 10, wherein:
the traffic data comprises one or more packets.

13. The apparatus of claim 10, wherein:
the at least one network failure comprises at least one of a link failure, a network switch failure or a network switch misconfiguration.

14. The apparatus of claim 10, wherein when the one or more processors further execute the instructions, the apparatus is configured to:
perform the determining the one or more tracker windows by determining that the one or more other network paths are transferring other traffic content across a network associated with the network path.

15. The apparatus of claim 10, wherein when the one or more processors further execute the instructions, the apparatus is configured to:
assign one or more priorities or weightings, to the one or more other network paths, comprising designating one or more percentages, to the one or more other network paths, indicating at least one percentage associated with the one or more other network paths allocated to transfer network traffic content across a network.

16. The apparatus of claim 15, wherein when the one or more processors further execute the instructions, the apparatus is configured to:
reassign the priorities or weightings in response to determining at least one failure associated with the at least one network path of the one or more other network paths.

17. The apparatus of claim 10, wherein when the one or more processors further execute the instructions, the apparatus is configured to:
migrate the at least the subset of the traffic data to the at least one network path of the one or more other network paths to transfer the at least the subset of the traffic data to the second communication device.

18. The apparatus of claim 10, wherein when the one or more processors further execute the instructions, the apparatus is configured to:
reclaim one or more resources associated with the at least one network failure, associated with the network path; and
reallocate the one or more resources to the one or more other network paths or one or more newly generated network paths.

19. A non-transitory computer-readable medium storing instructions that, when executed, cause:
determining a designated network path configured to transfer traffic data from a first communication device, via one or more network switches, to a second communication device;
determining at least one network failure, associated with the network path, causing at least a subset of the traffic data to be blocked along the network path;
determining one or more tracker windows associated with one or more other network paths that are available to transfer traffic content; and
selecting at least one network path of the one or more other network paths to transfer the at least the subset of the traffic data to the second communication device.

20. The non-transitory computer-readable medium of claim 19, wherein the instructions, when executed, further cause:
the determining the one or more tracker windows comprises determining that the one or more other network paths are transferring other traffic content across a network associated with the network path.
